(19) United States
(12) Patent Application Publication
(10) Pub. No.: US 2026/0122158 A1
(43) Pub. Date: Apr. 30, 2026

(54) ASPECTS OF MULTI-ACCESS POINT (AP) TRANSMISSION

(71) Applicants: Qinghua Li, San Ramon, OR (US); Dibakar Das, Hillsboro, CA (US); Dmitry Akhmetov, Hillsboro, OR (US); Juan Fang, Portland, OR (US); Shlomi Vituri, Tel Aviv (IL); Danny Alexander, Neve Efraim Monoson (IL); Carlos Cordeiro, Camas, WA (US); Laurent Cariou, Milizac (FR)

(72) Inventors: Qinghua Li, San Ramon, OR (US); Dibakar Das, Hillsboro, CA (US); Dmitry Akhmetov, Hillsboro, OR (US); Juan Fang, Portland, OR (US); Shlomi Vituri, Tel Aviv (IL); Danny Alexander, Neve Efraim Monoson (IL); Carlos Cordeiro, Camas, WA (US); Laurent Cariou, Milizac (FR)

(21) Appl. No.: 19/429,915

(22) Filed: Dec. 22, 2025

Related U.S. Application Data
(60) Provisional application No. 63/752,447, filed on Jan. 31, 2025.
(60) Provisional application No. 63/802,384, filed on May 8, 2025.

(51) Int. Cl. H04L 69/323; H04L 27/26

(52) U.S. Cl. CPC H04L 69/323; H04L 27/2646

(57) ABSTRACT

This disclosure describes systems, methods, and devices related to enhanced multi-AP transmission. A device may receive control information for coordinated transmission of a plurality of physical layer protocol data units (PPDUs) in a wireless network. The device may encode the PPDUs based on the control information, including a long training field (LTF) symbol duration and a guard interval (GI) to achieve temporal alignment. The device may decode signals to identify presence or absence of scheduled stations (STAs). The device may transmit the PPDUs with signaling fields reflecting a resource allocation for each STA, adjusting transmission for absent STAs without disrupting alignment or allocation.

### CROSS-REFERENCE TO RELATED APPLICATION(S)

This application claims the benefit of U.S. Provisional Application No. 63/752,447, filed Jan. 31, 2025, and U.S. Provisional Application No. 63/802,384, filed May 8, 2025, the disclosures of which are incorporated herein by reference as if set forth in full.

### BACKGROUND

Wireless devices are becoming more prevalent, necessitating efficient access to wireless channels. Standards are evolving to enhance connectivity, integrating advanced technologies in modern networks.

### BRIEF DESCRIPTION OF THE DRAWINGS

FIG. 1 is a network diagram illustrating an example network environment for enhanced multi-AP transmission, in accordance with one or more example embodiments of the present disclosure.

FIGS. 2, 3, 4A, 4B, and 5 depict illustrative schematic diagrams for enhanced multi-AP transmission, in accordance with one or more example embodiments of the present disclosure.

FIGS. 6, 7, 8, 9A, 9B, 9C, and 10 depict illustrative schematic diagrams for enhanced channel estimation, in accordance with one or more example embodiments of the present disclosure.

FIG. 11 illustrates a flow diagram of a process for an illustrative enhanced multi-AP transmission system, in accordance with one or more example embodiments of the present disclosure.

FIG. 12 illustrates a functional diagram of an exemplary communication station that may be suitable for use as a user device, in accordance with one or more example embodiments of the present disclosure.

FIG. 13 illustrates a block diagram of an example machine upon which any of one or more techniques (e.g., methods) may be performed, in accordance with one or more example embodiments of the present disclosure.

FIG. 14 is a block diagram of a radio architecture in accordance with some examples.

FIG. 15 illustrates an example front-end module circuitry for use in the radio architecture of FIG. 14, in accordance with one or more example embodiments of the present disclosure.

FIG. 16 illustrates an example radio IC circuitry for use in the radio architecture of FIG. 14, in accordance with one or more example embodiments of the present disclosure.

FIG. 17 illustrates an example baseband processing circuitry for use in the radio architecture of FIG. 14, in accordance with one or more example embodiments of the present disclosure.

### DETAILED DESCRIPTION

The following description and the drawings sufficiently illustrate specific embodiments to enable those skilled in the art to practice them. Other embodiments may incorporate structural, logical, electrical, process, algorithm, and other changes. Portions and features of some embodiments may be included in, or substituted for, those of other embodiments. Embodiments set forth in the claims encompass all available equivalents of those claims.

Wi-Fi 8 (IEEE 802.11bn or ultra high reliability (UHR)) is the next generation of Wi-Fi and a successor to the IEEE 802.11be (Wi-Fi 7) standard. In line with all previous Wi-Fi standards, Wi-Fi 8 will aim to improve wireless performance in general along with introducing new and innovative features to further advance Wi-Fi technology.

Coordinated spatial reuse (CSR, also denoted by C-SR, CoSR, or co-SR) and coordinated beamforming (CBF, also denoted by CoBF) are two multi-access point (multi-AP) features of Institute of Electrical and Electronics Engineers (IEEE) 802.11bn, i.e., Wi-Fi 8, the next-generation wireless networking standard that supports advanced multi-AP coordination to enhance network efficiency and performance. CSR is a technique that enables multiple access points (APs) to reuse the same frequency resources by coordinating their transmissions to minimize interference, thereby increasing spectral efficiency, such as when two APs in neighboring apartments transmit on the same channel but coordinate timing and power levels to avoid interfering with each other. CBF involves multiple APs collaboratively shaping their transmission beams toward intended clients and nullifying interference in unwanted directions, boosting signal quality and throughput; for example, a group of APs may jointly transmit to a user device at the cell edge, focusing the signal using directional beams. Two modes of CSR were proposed and adopted by Collab group, where the data PPDUs of sharing and shared APs have the same pre-UHR preamble, synchronization of UHR-SIG symbols and UHR-STF duration, resulting in APs starting UHR-LTF simultaneously. To solve coordination issues, one solution is for two APs to use 4×LTF symbol duration and the same GI; for the case of an absent STA, the shared AP sets the UHR-SIG as if the absent STA is served, but no signal is actually sent in UHR-LTF and UHR Data fields. Enabling CSR and CBF features in Wi-Fi 8 can improve device throughput. Additionally, an enhanced channel estimation system may leverage a larger P-matrix in encoding UHR-LTF of CSR data PPDU, supporting channel estimation for all or most spatial streams of two APs, allowing STAs to estimate both desired and interfering channels for interference mitigation. Assigning spatial streams can be managed via a trigger frame similar to that used for CBF, indicating whether the transmission is for CBF or CSR and which mode of CSR is used. The CSR data PPDU format may be similar to CBF, with a joint stream allocation for the APs in UHR-SIG. These features may be implemented in systems including processors, memory, and instructions, as well as network components like apparatus, station (STA), access point (AP), and other network elements. Numerous other configurations, processes, and algorithms may exist, some described in greater detail below.

CSR, also referred to as C-SR, CoSR, or co-SR, is a technique used in Wi-Fi networks where multiple APs reuse the same frequency band through coordination, thereby improving spectrum utilization and reducing co-channel interference. CBF, also referred to as CoBF, is a technique wherein multiple APs jointly manage their beam patterns to improve signal directionality and reduce interference. Both CSR and CBF are features of IEEE 802.11bn, commonly known as Wi-Fi 8, a next-generation wireless networking standard that supports advanced multi-AP coordination to enhance network efficiency and performance.

Example embodiments of the present disclosure relate to systems, methods, and devices for two aspects of IEEE 802.11bn (11bn) multi-AP transmission.

To address the issues discussed below, a straightforward solution is for the two APs to use 4×LTF symbol duration and the same GI. Additionally, the shared AP sets the UHR-SIG as if the absent STA still gets served, but no signal for the absent STA is actually sent in the UHR-LTF and UHR Data fields.

One or more advantages include enabling CSR and CBF features in Wi-Fi 8 so that the throughput of laptops may improve.

In one or more embodiments, a device or a system may comprise one or more components, which may include one or more of: apparatus, station (STA), access point (AP), and/or other network elements. At its most basic configuration, the device or system includes one or more processors, memory, and instructions. The processor(s) may be implemented using general-purpose microprocessors, digital signal processors (DSPs), field-programmable gate arrays (FPGAs), or other suitable computational entities capable of performing calculations or manipulations of information. The memory may include RAM, ROM, flash memory, or other storage media suitable for storing instructions and data necessary for system operation. These components, individually or in combination, enable the execution of processes that facilitate communication and functionality within the system.

Example embodiments of the present disclosure relate to systems, methods, and devices for enhanced channel training for coordinated spatial reuse.

In one embodiment, an enhanced channel estimation system may facilitate, a P-matrix larger than what each AP needs can be used to encode the UHR-LTF of the CSR data PPDU so that the UHR-LTF can support the channel estimation of all or most of the spatial streams of the two APs. With the increased UHR-LTF, the STAs can estimate the desired and interfering channels for the interference mitigation. To assign the spatial streams to the APs, a trigger frame preceding the data transmission can be used. The trigger frame can be like the one for coordinated beamforming (CBF or COBF). The trigger frame has fields to assign spatial streams to the APs and may also have a field to indicate whether the trigger frame is for CBF or CSR and which mode of CSR will be sent. The CSR data PPDU format may be like the one of CBF, which has a joint (or global) stream allocation for the two APs in the UHR-SIG field.

An enhanced channel estimation system may enable CSR feature in Wi-Fi 8 in order for the throughput of devices to be improved.

The above descriptions are for purposes of illustration and are not meant to be limiting. Numerous other examples, configurations, processes, algorithms, etc., may exist, some of which are described in greater detail below. Example embodiments will now be described with reference to the accompanying figures.

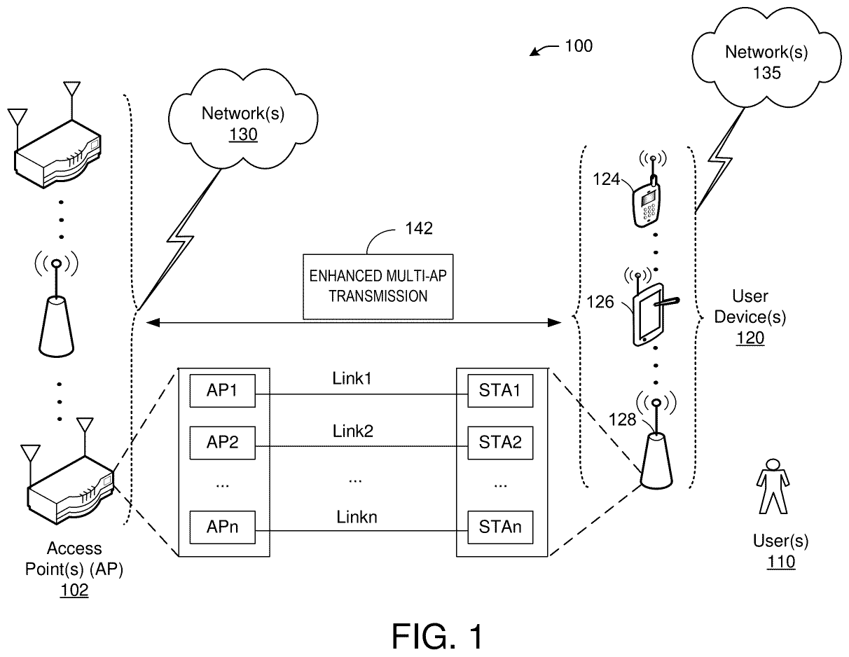

FIG. 1 is a network diagram illustrating an example network environment of enhanced multi-AP transmission, according to some example embodiments of the present disclosure. Wireless network 100 may include one or more user devices 120 and one or more access points(s) (AP) 102, which may communicate in accordance with IEEE 802.11 communication standards. The user device(s) 120 may be mobile devices that are non-stationary (e.g., not having fixed locations) or may be stationary devices.

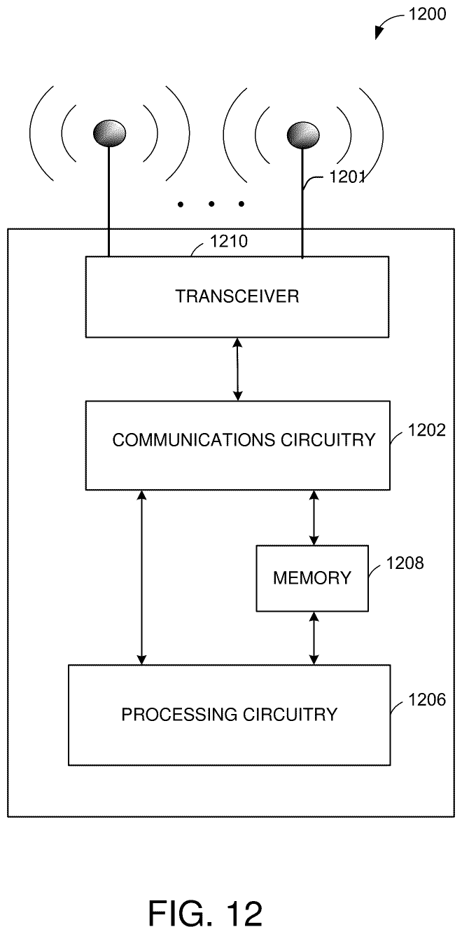

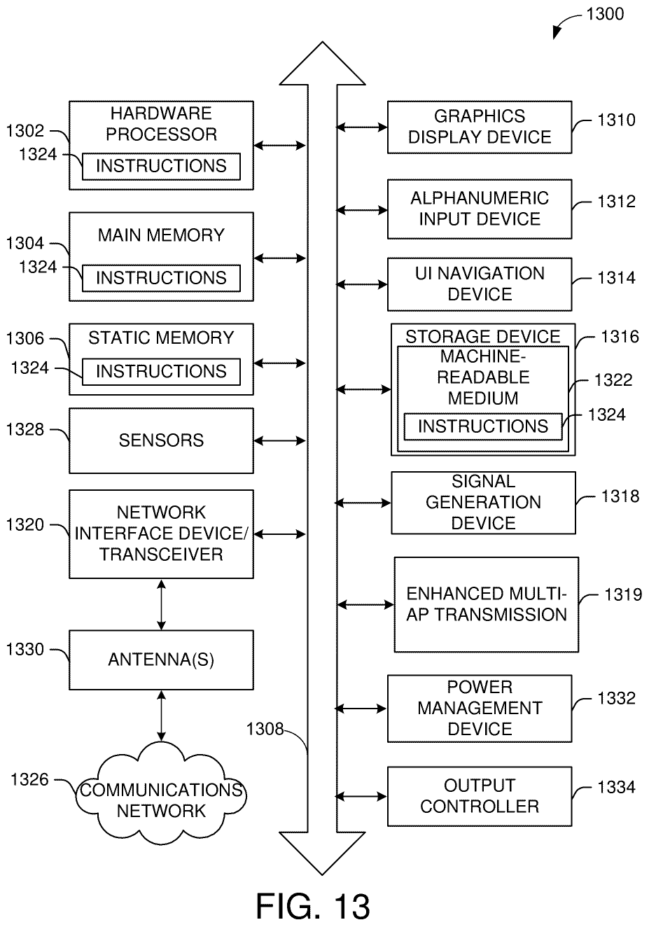

In some embodiments, the user devices 120 and the AP 102 may include one or more computer systems similar to that of the functional diagram of FIG. 12 and/or the example machine/system of FIG. 13.

One or more illustrative user device(s) 120 and/or AP(s) 102 may be operable by one or more user(s) 110. It should be noted that any addressable unit may be a station (STA). An STA may take on multiple distinct characteristics, each of which shape its function. For example, a single addressable unit might simultaneously be a portable STA, a quality-of-service (QoS) STA, a dependent STA, and a hidden STA. The one or more illustrative user device(s) 120 and the AP(s) 102 may be STAs. The one or more illustrative user device(s) 120 and/or AP(s) 102 may operate as a personal basic service set (PBSS) control point/access point (PCP/AP). The user device(s) 120 (e.g., 124, 126, or 128) and/or AP(s) 102 may include any suitable processor-driven device including, but not limited to, a mobile device or a non-mobile, e.g., a static device. For example, user device(s) 120 and/or AP(s) 102 may include, a user equipment (UE), a station (STA), an access point (AP), a software enabled AP (SoftAP), a personal computer (PC), a wearable wireless device (e.g., bracelet, watch, glasses, ring, etc.), a desktop computer, a mobile computer, a laptop computer, an Ultrabook™ computer, a notebook computer, a tablet computer, a server computer, a handheld computer, a handheld device, an internet of things (IoT) device, a sensor device, a PDA device, a handheld PDA device, an on-board device, an off-board device, a hybrid device (e.g., combining cellular phone functionalities with PDA device functionalities), a consumer device, a vehicular device, a non-vehicular device, a mobile or portable device, a non-mobile or non-portable device, a mobile phone, a cellular telephone, a PCS device, a PDA device which incorporates a wireless communication device, a mobile or portable GPS device, a DVB device, a relatively small computing device, a non-desktop computer, a “carry small live large” (CSLL) device, an ultra mobile device (UMD), an ultra mobile PC (UMPC), a mobile internet device (MID), an “origami” device or computing device, a device that supports dynamically composable computing (DCC), a context-aware device, a video device, an audio device, an A/V device, a set-top-box (STB), a blu-ray disc (BD) player, a BD recorder, a digital video disc (DVD) player, a high definition (HD) DVD player, a DVD recorder, a HD DVD recorder, a personal video recorder (PVR), a broadcast HD receiver, a video source, an audio source, a video sink, an audio sink, a stereo tuner, a broadcast radio receiver, a flat panel display, a personal media player (PMP), a digital video camera (DVC), a digital audio player, a speaker, an audio receiver, an audio amplifier, a gaming device, a data source, a data sink, a digital still camera (DSC), a media player, a smartphone, a television, a music player, or the like. Other devices, including smart devices such as lamps, climate control, car components, household components, appliances, etc. may also be included in this list.

As used herein, the term “Internet of Things (IoT) device” is used to refer to any object (e.g., an appliance, a sensor, etc.) that has an addressable interface (e.g., an Internet protocol (IP) address, a Bluetooth identifier (ID), a near-field communication (NFC) ID, etc.) and can transmit information to one or more other devices over a wired or wireless connection. An IoT device may have a passive communication interface, such as a quick response (QR) code, a radio-frequency identification (RFID) tag, an NFC tag, or the like, or an active communication interface, such as a modem, a transceiver, a transmitter-receiver, or the like. An IoT device can have a particular set of attributes (e.g., a device state or status, such as whether the IoT device is on or off, open or closed, idle or active, available for task execution or busy, and so on, a cooling or heating function, an environmental monitoring or recording function, a light-emitting function, a sound-emitting function, etc.) that can be embedded in and/or controlled/monitored by a central processing unit (CPU), microprocessor, ASIC, or the like, and configured for connection to an IoT network such as a local ad-hoc network or the Internet. For example, IoT devices may include, but are not limited to, refrigerators, toasters, ovens, microwaves, freezers, dishwashers, dishes, hand tools, clothes washers, clothes dryers, furnaces, air conditioners, thermostats, televisions, light fixtures, vacuum cleaners, sprinklers, electricity meters, gas meters, etc., so long as the devices are equipped with an addressable communications interface for communicating with the IoT network. IoT devices may also include cell phones, desktop computers, laptop computers, tablet computers, personal digital assistants (PDAs), etc. Accordingly, the IoT network may be comprised of a combination of “legacy” Internet-accessible devices (e.g., laptop or desktop computers, cell phones, etc.) in addition to devices that do not typically have Internet-connectivity (e.g., dishwashers, etc.).

The user device(s) 120 and/or AP(s) 102 may also include mesh stations in, for example, a mesh network, in accordance with one or more IEEE 802.11 standards and/or 3GPP standards.

Any of the user device(s) 120 (e.g., user devices 124, 126, 128), and AP(s) 102 may be configured to communicate with each other via one or more communications networks 130 and/or 135 wirelessly or wired. The user device(s) 120 may also communicate peer-to-peer or directly with each other with or without the AP(s) 102. Any of the communications networks 130 and/or 135 may include, but not limited to, any one of a combination of different types of suitable communications networks such as, for example, broadcasting networks, cable networks, public networks (e.g., the Internet), private networks, wireless networks, cellular networks, or any other suitable private and/or public networks. Further, any of the communications networks 130 and/or 135 may have any suitable communication range associated therewith and may include, for example, global networks (e.g., the Internet), metropolitan area networks (MANs), wide area networks (WANs), local area networks (LANs), or personal area networks (PANs). In addition, any of the communications networks 130 and/or 135 may include any type of medium over which network traffic may be carried including, but not limited to, coaxial cable, twisted-pair wire, optical fiber, a hybrid fiber coaxial (HFC) medium, microwave terrestrial transceivers, radio frequency communication mediums, white space communication mediums, ultra-high frequency communication mediums, satellite communication mediums, or any combination thereof.

Any of the user device(s) 120 (e.g., user devices 124, 126, 128) and AP(s) 102 may include one or more communications antennas. The one or more communications antennas may be any suitable type of antennas corresponding to the communications protocols used by the user device(s) 120 (e.g., user devices 124, 126 and 128), and AP(s) 102. Some non-limiting examples of suitable communications antennas include Wi-Fi antennas, Institute of Electrical and Electronics Engineers (IEEE) 802.11 family of standards compatible antennas, directional antennas, non-directional antennas, dipole antennas, folded dipole antennas, patch antennas, multiple-input multiple-output (MIMO) antennas, omnidirectional antennas, quasi-omnidirectional antennas, or the like. The one or more communications antennas may be communicatively coupled to a radio component to transmit and/or receive signals, such as communications signals to and/or from the user devices 120 and/or AP(s) 102.

Any of the user device(s) 120 (e.g., user devices 124, 126, 128), and AP(s) 102 may be configured to perform directional transmission and/or directional reception in conjunction with wirelessly communicating in a wireless network. Any of the user device(s) 120 (e.g., user devices 124, 126, 128), and AP(s) 102 may be configured to perform such directional transmission and/or reception using a set of multiple antenna arrays (e.g., DMG antenna arrays or the like). Each of the multiple antenna arrays may be used for transmission and/or reception in a particular respective direction or range of directions. Any of the user device(s) 120 (e.g., user devices 124, 126, 128), and AP(s) 102 may be configured to perform any given directional transmission towards one or more defined transmit sectors. Any of the user device(s) 120 (e.g., user devices 124, 126, 128), and AP(s) 102 may be configured to perform any given directional reception from one or more defined receive sectors.

MIMO beamforming in a wireless network may be accomplished using RF beamforming and/or digital beamforming. In some embodiments, in performing a given MIMO transmission, user devices 120 and/or AP(s) 102 may be configured to use all or a subset of its one or more communications antennas to perform MIMO beamforming.

Any of the user devices 120 (e.g., user devices 124, 126, 128), and AP(s) 102 may include any suitable radio and/or transceiver for transmitting and/or receiving radio frequency (RF) signals in the bandwidth and/or channels corresponding to the communications protocols utilized by any of the user device(s) 120 and AP(s) 102 to communicate with each other. The radio components may include hardware and/or software to modulate and/or demodulate communications signals according to pre-established transmission protocols. The radio components may further have hardware and/or software instructions to communicate via one or more Wi-Fi and/or Wi-Fi direct protocols, as standardized by the Institute of Electrical and Electronics Engineers (IEEE) 802.11 standards. In certain example embodiments, the radio component, in cooperation with the communications antennas, may be configured to communicate via 2.4 GHz channels (e.g. 802.11b, 802.11g, 802.11n, 802.11ax), 5 GHz channels (e.g. 802.11n, 802.11ac, 802.11ax, 802.11be, 802.11bn, etc.), 6 GHZ channels (e.g., 802.11ax, 802.11be, 802.11bn, etc.), or 60 GHZ channels (e.g. 802.11ad, 802.11ay). 800 MHz channels (e.g. 802.11ah). The communications antennas may operate at 28 GHz and 40 GHz. It should be understood that this list of communication channels in accordance with certain 802.11 standards is only a partial list and that other 802.11 standards may be used (e.g., Next Generation Wi-Fi, or other standards). In some embodiments, non-Wi-Fi protocols may be used for communications between devices, such as Bluetooth, dedicated short-range communication (DSRC), Ultra-High Frequency (UHF) (e.g. IEEE 802.11af, IEEE 802.22), white band frequency (e.g., white spaces), or other packetized radio communications. The radio component may include any known receiver and baseband suitable for communicating via the communications protocols. The radio component may further include a low noise amplifier (LNA), additional signal amplifiers, an analog-to-digital (A/D) converter, one or more buffers, and digital baseband.

In one embodiment, and with reference to FIG. 1, a user device 120 may be in communication with one or more APs 102. For example, one or more APs 102 may implement an enhanced multi-AP transmission 142 with one or more user devices 120. The one or more APs 102 may be multi-link devices (MLDs) and the one or more user device 120 may be non-AP MLDs. Each of the one or more APs 102 may comprise a plurality of individual APs (e.g., AP1, AP2, . . . , APn, where n is an integer) and each of the one or more user devices 120 may comprise a plurality of individual STAs (e.g., STA1, STA2, . . . , STAn). The AP MLDs and the non-AP MLDs may set up one or more links (e.g., Link1, Link2, . . . , Linkn) between each of the individual APs and STAs. It is understood that the above descriptions are for the purposes of illustration and are not meant to be limiting.

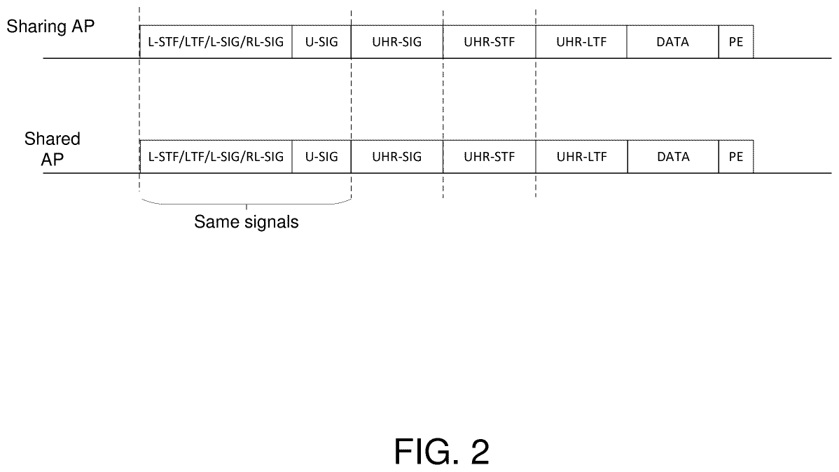

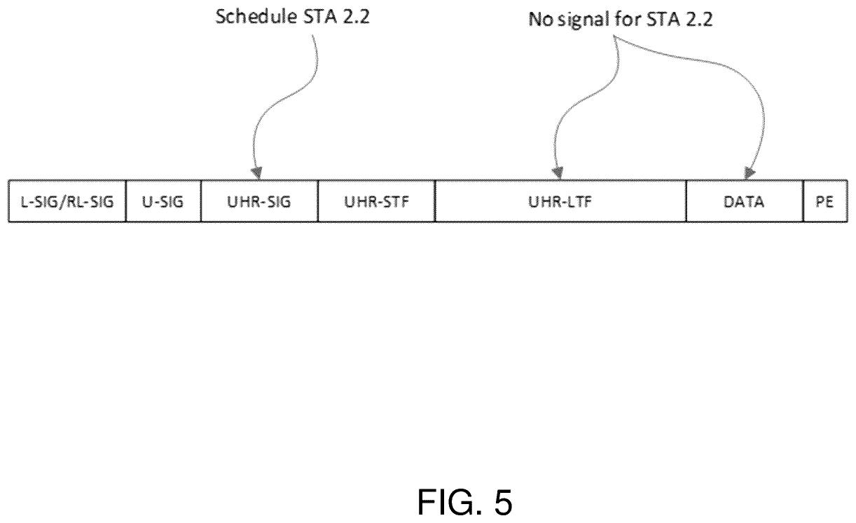

FIGS. 2-5 depict illustrative schematic diagrams for enhanced multi-AP transmission, in accordance with one or more example embodiments of the present disclosure.

Coordinated spatial reuse (denoted by CSR or C-SR or CoSR or co-SR) and coordinated beamforming (denoted by CBF or CoBF) are two multi-AP features of IEEE 802.11bn, i.e., Wi-Fi 8. CBF and the synchronous UHR mode of CSR are illustrated in FIG. 2. It is desired to address two problems in CSR and CBF.

### Problem 1

In CSR, the LENGTH field in L-SIG is set to the same value in both CSR PPDUs, whose formats can be one of the three combinations, i.e., UHR+UHR, UHR+EHT, and EHT+EHT. Because the OFDM symbol durations in the preamble and the data field can be different, e.g., 2× symbol duration and 4× symbol duration, it is hard to align the termination of the two PPDUs if the two APs choose LTF symbol duration and GI independently. Broadcom complained about this during the discussions. If the two PPDUs don't end at the same time, the response frames, e.g., acknowledgement (Ack) frames or block ack (BA) frames, from the receiver STAs can't be aligned. The misalignment may cause a problem in detecting the response frames or aligning the MAC slot boundary. It is possible to propose some restrictions on the duration of the fields in the CSR PPDU for synchronizing the terminations of the two PPDUs.

### Problem 2

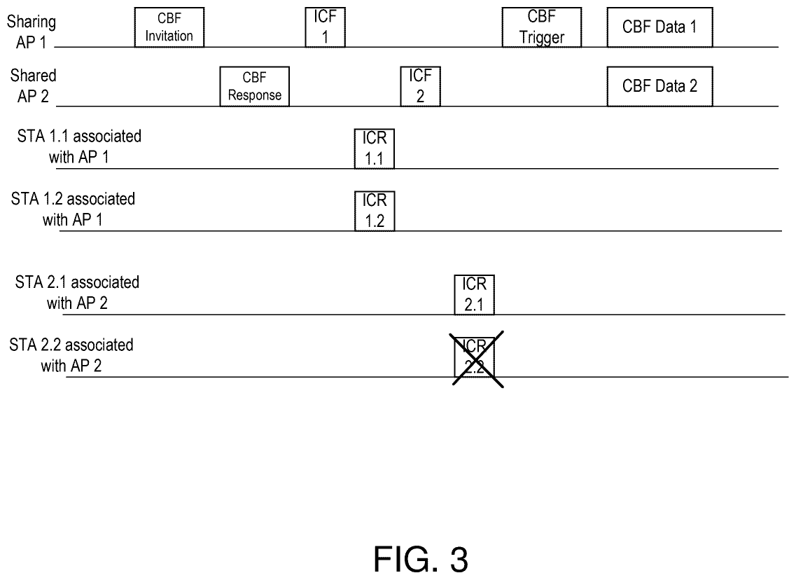

The frame exchange sequence of CBF is illustrated in FIG. 3, where CBF invitation and CBF trigger are also denoted by CBF invite and CBF sync, respectively. The shared AP needs to tell the sharing AP the transmission parameters of the shared AP's scheduled STA, e.g., STA ID, resource allocation, and MCS, via the CBF response frame before the CBF data transmission. After the CBF response frame, the shared AP may need to wake up the scheduled STA, e.g., using ICF frame. If the responding ICR frame is not received, the shared AP should drop the STA from the CBF data transmission. However, there is no chance in the frame exchange sequence for the shared AP to ask the sharing AP to drop the STA from the CBF transmission. The procedure about how to handle the absent STA has not been discussed. It is possible to propose a way to handle the absence.

### Solutions to Problem 1

### Option 1—4×LTF Symbol:

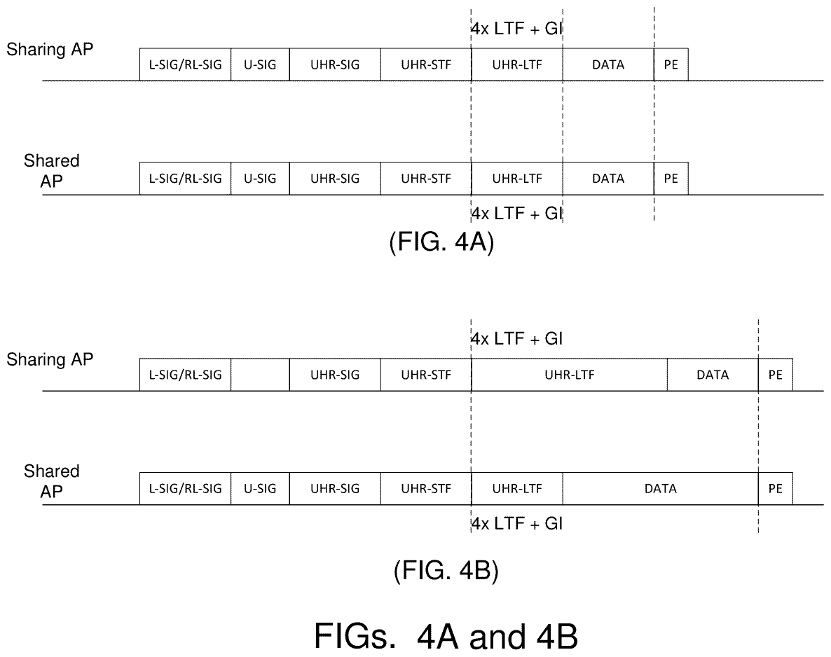

Because the U-SIG contents in FIG. 2 need to be the same for the two CSR PPDUs and the number of UHR-SIG symbols is specified in the U-SIG, the start time of UHR-STF is the same for both CSR PPDUs. Because the UHR-STF has a fixed duration, the start time of UHR-LTF is the same for both CSR PPDUs. To align the termination of the two PPDUs, it is possible to choose an LTF symbol duration that is the same as the data OFDM symbol, i.e., 4× symbol duration. Note that the same GI is always applied to both LTF symbol and data symbol. For example, 4×LTF symbol duration is 12.8 microseconds and the GI can be 0.8, 1.6, and 3.2 microseconds, which matches the data symbol duration of HE, EHT, and UHR. By choosing 4× symbol duration and the same GI for the two CSR PPDUs, the symbol boundaries of the data or LTF symbols of the two PPDUs are aligned symbol by symbol. Finally, to align the termination of the two PPDUs, the two APs just need to choose the same packet extension (PE). In this option, the two APs can select different numbers of LTF symbols. For example, AP1 sends two streams and uses two LTF symbols while AP2 sends one stream and uses one LTF symbol. The idea is illustrated in FIGS. 4A and 4B.

### Option 2—Same UHR or EHT LTF Field Duration:

In this option, the LTF symbol duration does not need to be 4× symbol duration. Instead, the LTF symbol duration just needs to be the same for the two PPDUs and needs to be indicated in the CSR control frame before the CSR data PPDUs, e.g., CSR invite, CSR response, and CSR sync. If the LTF symbol duration is not 4× symbol duration, then the UHR or EHT LTF field durations of the two PPDUs need to be the same. Namely, the UHR or EHT LTF fields start and end at the same time. Because the numbers of spatial streams can be different for the two PPDUs, the feature of Extra EHT (or UHR) LTF (symbols) can be used for aligning the field boundaries. For example, the sharing AP sends one spatial stream, and the shared AP sends two spatial streams. Instead of one UHR or EHT LTF symbol, the sharing AP uses two UHR or EHT LTF symbols the same as the shared AP. Namely, one AP may use one or more extra LTF symbols to accommodate the longer LTF of the other AP. In this option, the numbers of data OFDM symbols and PE durations are the same for both APs, the PE and LENGTH field value (or the number of data OFDM symbols) are indicated in the CSR control frame before the CSR data PPDUs, e.g., CSR invite, CSR response, and CSR sync.

### Solution to Problem 2

Using the example in FIG. 3, STA 2.2 may not get woken up by ICF 2 and fail to send ICR 2.2. In this case, the shared AP should not continue to send data to STA 2.2 because it wastes energy and resources. However, the shared AP cannot tell the sharing AP to drop STA 2.2 after sending the CBF response frame. The shared AP continues to follow the resource allocation specified in the CBF trigger and specifies the resource allocation and transmission parameters like MCS and code type in UHR-SIG for STA 2.2 but sends no signal for STA 2.2 in the UHR-LTF and Data fields for saving energy and reducing interference. Namely, for the STA that was initially scheduled in CBF response but latter got dropped for some reason, the shared AP can set the UHR-SIG of the CBF data PPDU as if the dropped STA still gets served by the CBF data PPDU but the shared AP sends no signal or very low-power signal for the dropped STA.

A similar problem for absent STA exists in CSR. The frame exchange sequence is very similar to the one in FIG. 3, simply replacing CBF by CSR. The shared AP indicates the required number of UHR-SIG or EHT-SIG symbols in the CSR response frame. The sharing AP allocates enough UHR-SIG or EHT-SIG symbols accordingly via the CSR trigger frame. The allocated SIG symbols may accommodate two (or more) STAs but one of the two may get dropped for some reason from the CSR data PPDU. The shared AP should keep the number of UHR-SIG or EHT-SIG symbols the same as the one allocated in the CSR trigger. In the UHR-SIG or EHT-SIG, the indicated number of STAs can be the number of STAs actually getting served, excluding the dropped STA(s), and the leftover space in UHR-SIG or EHT-SIG is filled by dummy bits or dummy user field(s).

It is understood that the above descriptions are for the purposes of illustration and are not meant to be limiting.

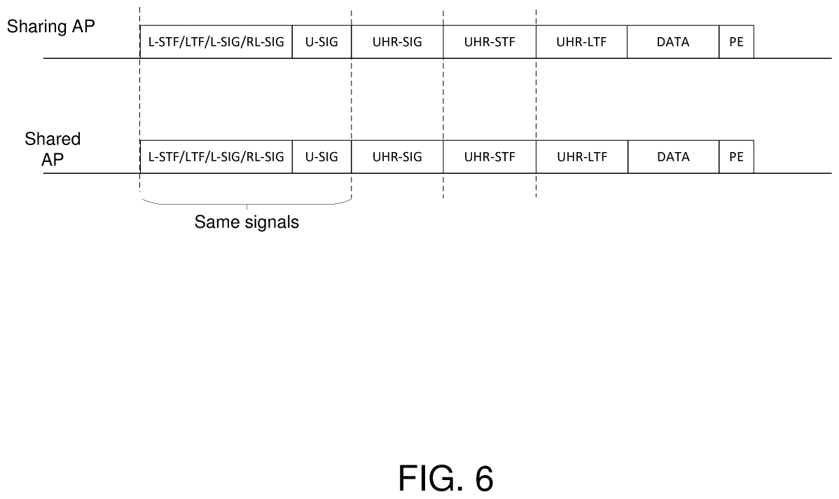

FIGS. 6-10 depict illustrative schematic diagrams for enhanced channel estimation, in accordance with one or more example embodiments of the present disclosure.

Coordinated spatial reuse (denoted by CSR or C-SR or CoSR or co-SR) will be a feature in IEEE 802.11bn, i.e., Wi-Fi 8. Two modes were proposed and adopted by Collab group. One of the CSR modes adopted by Collab is shown in FIG. 6. The data PPDUs of sharing AP and shared AP have the same pre-UHR preamble, which consists of L-STF/L-LTF/L-SIG/RL-SIG/U-SIG. Because the number of UHR-SIG symbols is specified in the U-SIG and the U-SIG contents and signals of the two APs are the same, the number of UHR-SIG symbols are the same. Furthermore, the duration of the UHR-STF is the same for all the APs. As a result, the APs start the UHR-LTF at the same time.

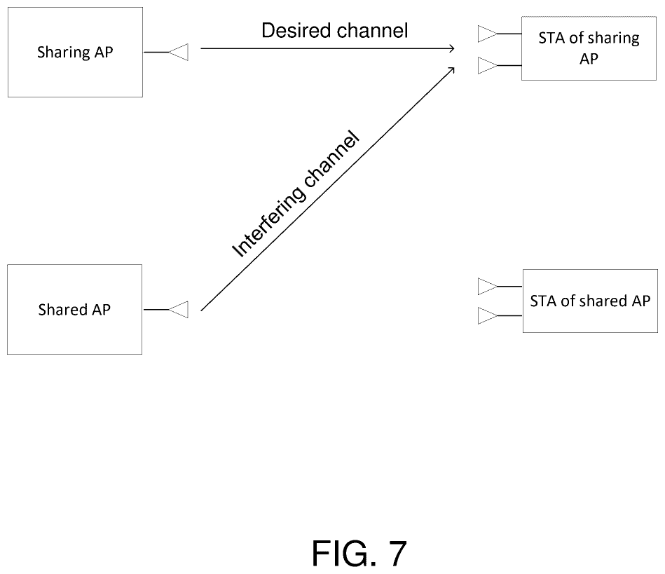

This causes a problem. The channel training symbols, which are the UHR-LTF symbols sent by the APs, are the same or partially the same when the number of spatial streams of each AP is picked from 1, 2, 3, 4, 7, and 8. Because the training symbols are the same or partially the same, the intended STA can't distinguish the desired channel from the interfering channel. Instead, the estimated channel is an aggregation of the desired and interfering channels as illustrated in FIGS. 2-3 and Equation (2). In FIG. 7, even though each STA has multiple antennas, which can mitigate fully or partially the interference from the other AP, the interference can't be mitigated because each STA doesn't know the desired and interfering channels, respectively.

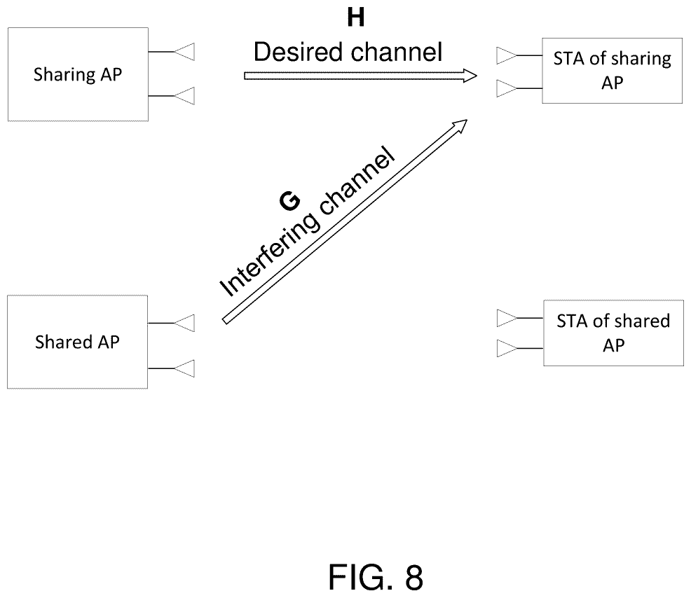

Using FIG. 8, it is illustrated that the availability of the desired channel and interfering channel improves the performance even if there are no additional antennas at the STA. Denote the channel matrix of the desired link from sharing AP to its STA by H. Denote the channel matrix of the interfering link from the shared AP to the STA of the sharing AP by G. The ideal linear MMSE receiver of the STA of the sharing AP is given by:

W=(H+H+G*G+σ²I)⁻¹H*, (1)
where G*G+σ²I is the covariance matrix of interference plus noise. With the knowledge of the covariance matrix, the STA can suppress the strong interference from a certain direction(s). Besides, the log-likelihood ratios (LLRs) of the demodulated codebits can be calculated accurately such that the LDPC decoding doesn't degrade. In contrast, without the knowledge of the covariance matrix, the STA can't suppress the interference using the spatial structure of the interference and can't calculate the LLRs accurately. The mismatched MMSE receiver of the existing scheme is given by

W=((H+G)*(H+G)+σ²I)⁻¹(H+G)*, (2)
where H+G is the channel estimated by the STA for decoding its data and σ²I is the covariance matrix of the interference plus noise. As a result, the STA tries to demodulate the summation of the data symbols from the two APs instead of the data symbols from its AP. For non-linear receivers like sphere decoder, the covariance matrix of interference plus noise, i.e., G*G+σ²I, also needs to be known. For the existing scheme, the covariance matrix is estimated as σ²I, which results into performance degradation. The examples in FIGS. 7 and 8 illustrate the problem at the STA of the sharing AP. The problem is the same at the STA of the shared AP due to symmetry.

In addition to the spatial demultiplexing of the data streams, the spatial demultiplexing of the pilots from the APs also benefits from the knowledge of the desired and interfering channels similarly.

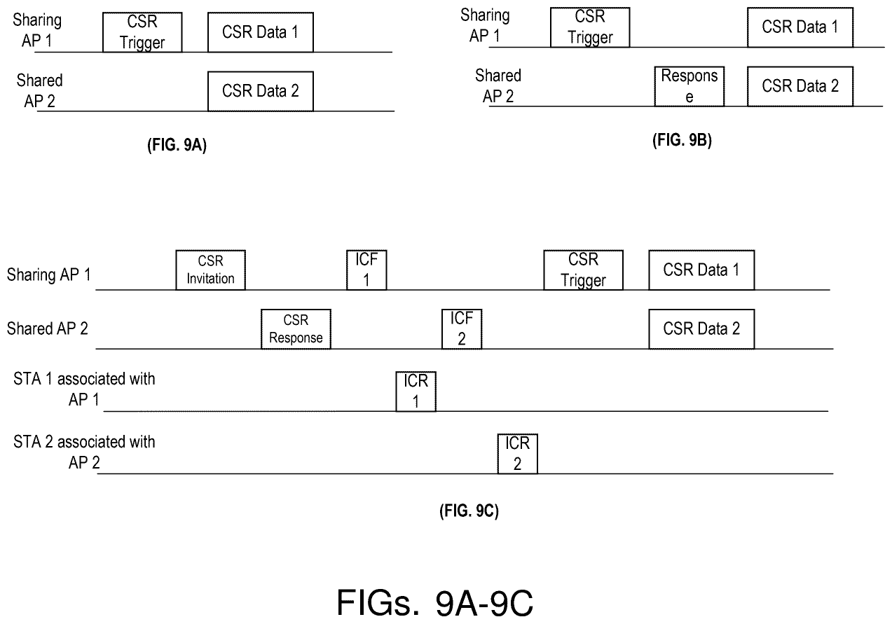

The frame exchange sequences for CSR are shown in FIGS. 9A, 9B and 9C. The frame exchange sequences of CSR and CBF can be unified. For example, the same frame type can be used for triggering CSR and CBF and an indication within the trigger frame indicates which of CSR and CBF is triggered. The CSR invitation (or CSR invite or CSR initiation) and CSR response can be ICF and ICR frames addressed to AP instead of STA. The ICF and ICR in FIGS. 9A, 9B and 9C are addressed to STAs and are optional. 1. Increased LFT Capacity:

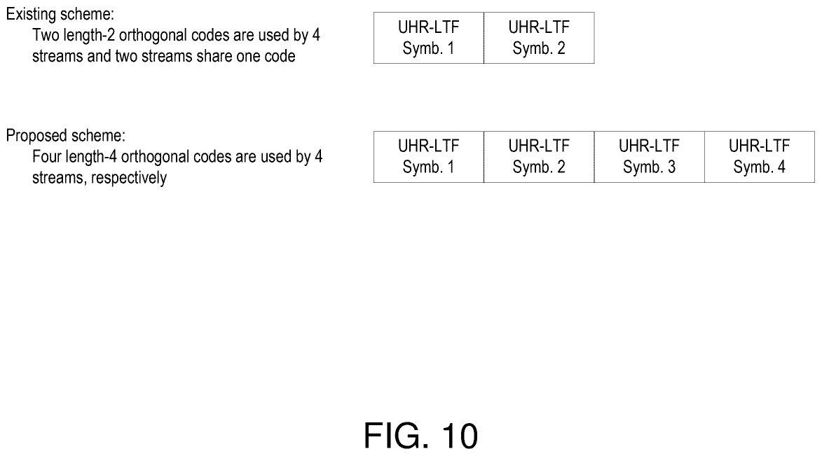

In the existing scheme, each AP only allocates just enough LTF symbols for its own spatial streams such that the desired and interfering channels can't be distinguished by the STAs. To solve the problem, in the trigger frame (or response frame or invitation frame) in FIGS. 9A, 9B and 9C, additional LTF symbols can be allocated for accommodating the spatial streams of both the sharing and the shared APs. For example, in FIG. 8, the sharing and shared APs send two spatial streams to their STAs, respectively. In the existing scheme, the LTF (UHR-LTF or EHT-LT) of each CSR data PPDU is usually encoded by 2×2 P-matrix and only two orthogonal P-matrix codes are available for the total of four streams. Even though a P-matrix larger than 2×2 can be used, only the first two codes are allocated. In this solution, 4×4 P-matrix instead of 2×2 P-matrix is employed to encode the LTF for accommodating total 4 spatial streams, 2 for each AP. The first two P-matrix codes are allocated to the sharing AP and the other two are allocated to the shared AP, or vice versa. The difference of the existing scheme and the proposed scheme herein is illustrated in FIG. 10.

### 2. P-Matrix Code Assignment:

The stream allocation can be indicated in a frame before the CSR data PPDU like trigger frame, invitation frame, response frame, ICF, and ICR. The sharing AP may allocate some or all of the spatial streams to the shared AP, and the shared AP may follow the allocation. Each AP may finally indicate how its streams are allocated to its STA(s) in the preamble of the CSR data PPDU so that its STA can find the allocated spatial streams. The stream allocation essentially assigns orthogonal P-matrix code(s) to the STA for the STA to estimate its channel.

For example, FIG. 8, the sharing AP allocates streams 1 and 2 to its STA and the shared AP allocates streams 3 and 4 to its STA. Because it is desired that the shared AP uses the streams other than those used by the sharing AP, the shared AP may need to use the preamble format of MU-MIMO PPDU for allocating streams 3 and 4 to its STA. In addition, for backward compatibility, a fake user field may be needed for reusing the encoding of spatial configuration subfield defined in EHT such that the shared AP can allocate the streams taken by the sharing AP to the fake user. For example, in FIG. 8, shared AP schedules two users, a fake user and a real one. The fake user takes streams 1 and 2, which are already taken by the sharing AP, and the real user takes streams 3 and 4. If the shared AP gets the first streams, the sharing AP may need to use a fake user to skip the streams taken by the shared AP. Namely, the order of sharing AP and shared AP can be switched in the stream allocation process. Note that the fake user incurs some overhead. Because the sharing AP is the owner of the TXOP, it is desired that the shared AP pays the overhead of adding the fake user field. Because the number of OFDM symbols is the same for the two UHR-SIGs of the two CSR data PPDUs, the fake user decreases the efficiency of both UHR-SIGs.

Note that the number of CSR APs and the maximum number of spatial streams per CSR AP are limited to two and four, respectively. If each CSR STA can support 8×8 P-matrix reception, then the proposed scheme works fine. However, some STA may only support up to 4×4 P-matrix reception. In this case, if the total number of streams of the two APs is greater than 4, e.g., 3+2>4, the 4×4 P-matrix can still be used by the two APs. Two subsets of the four orthogonal P-matrix codes are assigned to the two APs, respectively such that the overlap of the two subsets is minimized. For example, the sharing AP gets codes 1, 2, and 3, and the shared AP gets codes 3 and 4 instead of codes 1 and 2 as in the existing scheme. The stream assignment or allocation may be done by the sharing AP.

For simplifying the stream allocation and minimizing the overlap, the sharing AP specifies the number of UHR-LTF symbols, i.e., the P-matrix size, denoted by N. The sharing AP chooses P-matrix codes for its spatial streams in increasing order, e.g., from code 1 to code N, the same as the legacy 11n/ac/ax/be. The shared AP chooses P-matrix codes for its spatial streams in decreasing order, e.g., from code N down to code 1. Namely, sharing and shared APs takes P-matrix codes in opposite orders for minimizing the overlap. Or, sharing AP takes codes 1, 2, . . . , N₁ for its N₁ streams, and shared AP takes codes N−N₂+1, N−N₂+2, . . . , N for its N₂ streams. This rule may be defined in UHR specification so that no stream assignment needs to be exchanged between the APs. The order of sharing and shared APs can be switched in the stream assignment. Alternatively, if it is desired that the sharing and shared APs takes the first and last codes of the P-matrix, respectively, then the specification may index the codes in opposite orders for the two APs, respectively. For example, the codes are indexed by the sharing AP as 1, 2, 3, 4 while the same codes are indexed by the shared AP as 4, 3, 2, 1. With the different indexes, the sharing and shared AP can take codes in increasing order.

To improve the UHR-SIG efficiency, it is possible to remove the fake user at the cost of backward compatibility. As illustrated in the two examples above, the fake user is not needed. However, the STA needs to know its AP is the sharing or shared AP so that the STA can choose the corresponding codes for the channel estimation. This can be done as follows. In the U-SIG of CSR data PPDU, there two BSS colors in two different subfields, one for the sharing AP and the other for the shared AP. By matching the BSS color and checking the subfield location of the matched BSS color, the STA knows whether its AP is the shared or sharing AP. Because a decreasing order of code indexing or a different starting code is needed for the STA of the shared AP, full backward compatibility is not achieved. The role of sharing or shared AP is determined by which AP sends the CSR trigger or CSR invitation.

### 3. Signaling for Stream Allocation:

The stream allocations to the two APs may be specified in the CSR trigger frame in FIGS. 9A, 9B, and 9C. In FIG. 9C, using the CSR invitation frame (maybe also called CSR invite), the sharing AP invites the shared AP to the CSR transmission and may make a proposal to the shared AP about the stream allocation and the LTF P-matrix size of the CSR data PPDU. Using the CSR response frame, the shared AP confirms the reception of the invitation and the acceptance of the stream allocation and P-matrix size. The stream allocation may include an indication about whether the shared AP should use the P-matrix codes in the legacy increasing order or not. If the shared AP does not accept the stream allocation or the P-matrix size is too large for its STA, the shared AP may not send a response frame to the sharing AP or the shared AP may send a response frame with a counter proposal to the sharing AP. If the sharing AP does not receive the response frame within a certain time, e.g., a timeout interval, after the CSR invitation frame, then the sharing AP won't trigger the shared AP for CSR transmission. In some embodiment, the stream allocation may not be included in the invitation frame and response frame for simplicity. For example, the sharing AP and shared AP just take the first and the last portions of the P-matrix codes, respectively without knowing how many streams the other AP takes. In some embodiment, the P-matrix size but not the stream allocation may be included in the invitation frame for simplicity.

The RA of CSR invitation frame may be the MAC address of the shared AP. In one embodiment, the frame type of the invitation frame and response frame may be BSRP and BA, respectively. In another embodiment, the CSR invitation frame may be of a trigger frame type. The trigger type of the CSR trigger frame may be Basic, whose value in the trigger type subfield is 0. The size of the LTF P-matrix used by the CSR data PPDU may be specified in the common info field. The streams taken by the sharing AP may be specified in a user info field, e.g., the first user info field. In the user info field, the spatial configuration subfield indicates the stream allocation as shown in Table 36-42 of EHT specification. In the table, Nss [1] and Nss [2] (or Nss [2] and Nss [1]) may specify the number of streams allocated to the sharing and shared APs, respectively. For example, B5−B0=000100 allocates two streams to the sharing AP and two (or up to two) streams to the shared AP. For another example, B5−B0=000101 allocates three streams to the sharing AP and two (or up to two streams) to the shared AP. If the total number of LTF symbols, i.e., the P-matrix size, is 4, which may be specified in the common info field of the trigger frame, the sharing AP may take the first streams, e.g., {1,2,3} and the shared AP may take the last streams, e.g., {3,4} for minimizing the stream overlap.

The response frame may be of an acknowledgement frame type or a trigger frame type. The RA may be the MAC address of the sharing AP.

TABLE 36-42
Spatial Configuration subfield encoding

| | | N_{SS} | N_{SS} | N_{SS} | N_{SS} | N_{SS} | N_{SS} | N_{SS} | N_{SS} | Total | Total |
|---|---|---|---|---|---|---|---|---|---|---|---|
| Nᵤₛₑᵣ | B5 . . . B0 | [1] | [2] | [3] | [4] | [5] | [6] | [7] | [8] | N_{SS} | entries |
| 2 | 000000- | 1-4 | 1 | | | | | | | 2-5 | 10 |
| | 000011 | | | | | | | | | | |
| | 000100- | 2-4 | 2 | | | | | | | 4-6 | |
| | 000110 | | | | | | | | | | |
| | 000111- | 3-4 | 3 | | | | | | | 6-7 | |
| | 001000 | | | | | | | | | | |
| | 001001 | 4 | 4 | | | | | | | 8 | |

### 4. Unified Signaling for CBF and CSR:

Note that the proposed CSR scheme and CBF are similar except no beamforming and nulling is applied by the APs for the proposed CSR scheme. The stream allocation is needed for both CBF and the proposed CSR scheme. It is possible to reuse the signaling of CBF for the proposed CSR scheme. The CSR invitation frame (or called CBF/CSR invitation frame) in FIGS. 9A, 9B, and 9C can indicate the duration of the data PPDU and which scheme is selected, i.e., CBF or CSR and which CSR scheme is selected, e.g., common L-SIG or common L-SIG and U-SIG and whether the proposed CSR with stream allocation is selected. Besides the scheme indication, if CBF or CSR with stream allocation is selected, the CBF/CSR invitation frame can allocate the spatial streams to the sharing AP and/or the shared AP and indicate the number of UHR-LTF symbols, i.e., the total number of spatial streams that can be supported in the data PPDU. For CBF, the CBF/CSR invitation frame can further allocate the spatial streams to its STAs. For CBF and the proposed CSR scheme, if a STA of the shared AP cannot support the indicated number of UHR-LTF symbols, which requires a certain buffer size, the STA should not be selected by the shared AP for the subsequent data transmission. In the CSR response frame (or called CBF/CSR response frame) in FIGS. 9A, 9B, and 9C, for the CBF and the proposed CSR scheme, the shared AP allocates the spatial streams, which are given by the sharing AP, to the selected STAs of the shared AP, and tells the sharing AP the stream allocation. For the proposed CSR scheme, the shared AP may not need to report its stream allocation to its STA(s) to the sharing AP via the CBF/CSR response frame but the number of selected STAs needs to be reported. Based on the number of the selected STAs of each AP, the sharing AP determines the UHR-SIG length of the data PPDU. For CBF, besides the stream allocation, the MCS of each selected STA of the shared AP is reported in the CBF/CSR response frame. The reason is that the UHR-SIGs of the CBF data PPDUs need to be the same such that the shared AP needs to tell the sharing AP the detailed settings of the shared AP's STAs like stream allocation and MCS. For the proposed CSR scheme, if it is desired to reuse the CBF signaling as much as possible, the shared AP can report the same as in the CBF. For the proposed CSR scheme, if one wants to reduce the overhead, the MCS of the shared AP's STA doesn't need to be reported. For CBF and CSR, the CSR trigger frame (or called CBF/CSR trigger frame) in FIGS. 9A, 9B, and 9C may again carry an indication, indicating which scheme is selected, i.e., CBF or CSR and which CSR scheme is selected, e.g., common L-SIG or common L-SIG and U-SIG and whether the proposed CSR with stream allocation is selected for simplicity. For CBF, the CBF/CSR trigger frame carries the AIDs of all the selected STAs, the stream allocations, and the MCSs of the sharing and shared APs. For the proposed CSR scheme, if it is desired to reuse the CBF signaling, the trigger frame can carry the same information about selected STA as the CBF. For the proposed CSR scheme, if one wants to reduce the overhead, the MCSs of the selected STAs don't need to be announced in the trigger frame. For CBF, the data PPDU format is like the one of downlink MU-MIMO except differences in the U-SIG and UHR-SIG, e.g., two BSS colors in U-SIG. Besides the L-SIG and U-SIG, the UHR-SIGs of the two simultaneous data PPDUs can be the same for the proposed CSR scheme. For the proposed CSR scheme, if one wants to reduce the overhead, the L-SIGs and U-SIGs are the same for the two PPDUs, but the UHR-SIG of each AP only carries the information about its STAs. Note that the duration of the two UHR-SIGs is always the same for the CBF and the proposed CSR scheme.

It is understood that the above descriptions are for the purposes of illustration and are not meant to be limiting.

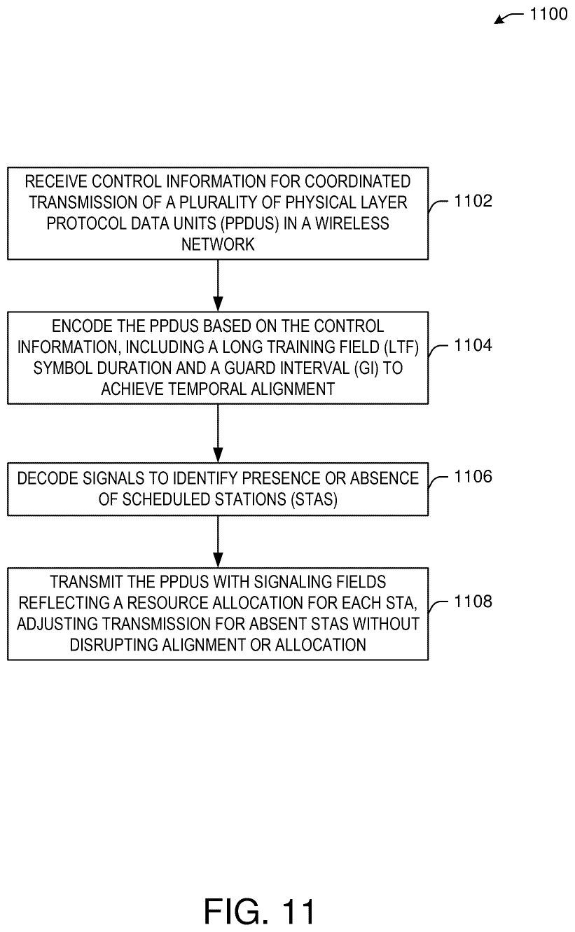

FIG. 11 illustrates a flow diagram of illustrative process 1100 for an enhanced multi-AP transmission system, in accordance with one or more example embodiments of the present disclosure.

At block 1102, a device (e.g., the user device(s) 120 and/or the AP 102 of FIG. 1 and/or the enhanced multi-AP transmission device 1319 of FIG. 13) may receive control information for coordinated transmission of a plurality of physical layer protocol data units (PPDUs) in a wireless network.

At block 1104, the device may encode the PPDUs based on the control information, including a long training field (LTF) symbol duration and a guard interval (GI) to achieve temporal alignment.

At block 1106, the device may decode signals to identify presence or absence of scheduled stations (STAs).

At block 1108, the device may transmit the PPDUs with signaling fields reflecting a resource allocation for each STA, adjusting transmission for absent STAs without disrupting alignment or allocation.

In one or more embodiments, a device may select the LTF symbol duration to be equal to four times a base symbol duration in order to align PPDUs. This approach addresses the technical challenge of achieving precise temporal alignment across multiple transmissions. For example, using a quadruple base duration helps synchronize the start and end times of packets from different sources, minimizing interference and improving throughput.

In one or more embodiments, a device may align a packet extension for each PPDU to synchronize termination from multiple access points. This feature solves the problem of unsynchronized packet endings that can lead to collisions or wasted resources. For instance, by extending packets to match termination times, the device ensures seamless coordination even in dense network environments.

In one or more embodiments, a device may indicate the LTF symbol duration, the GI, and a number of LTF symbols. This explicit signaling tackles the issue of ambiguity in transmission parameters, which can cause misinterpretation and errors during decoding. For example, including these values in signaling fields allows receiving stations to correctly process incoming packets and maintain robust connections.

In one or more embodiments, a device may assign extra LTF symbols in a PPDU to match field duration when the number of spatial streams differs between access points. This solution addresses mismatched field durations that arise from varying spatial stream counts, preventing misalignment and data loss. As an example, when one access point transmits more spatial streams than another, adding extra LTF symbols compensates for the difference, keeping all transmissions synchronized.

In one or more embodiments, a device may refrain from transmitting a signal for an absent STA while maintaining the indicated resource allocation. This strategy overcomes the problem of resource allocation disruption due to unexpected station absence. For example, if a scheduled station is missing, the device preserves the resource mapping for future transmissions, avoiding unnecessary reconfiguration.

In one or more embodiments, a device may transmit the signaling fields and an LTF for an absent scheduled station while omitting at least a data field. This approach helps maintain protocol consistency and allocation structure without sending unnecessary data. For instance, by sending only the signaling and training fields, the device informs other network elements of the scheduled resource without wasting bandwidth.

In one or more embodiments, a device may fill remaining bits or user fields with dummy values when a station is dropped. This feature solves the challenge of incomplete packet structure that could otherwise cause errors in processing or interpretation. For example, populating unused fields with predefined dummy values ensures that packet integrity is preserved and downstream devices can handle dropped stations gracefully.

It is understood that the above descriptions are for the purposes of illustration and are not meant to be limiting.

FIG. 12 shows a functional diagram of an exemplary communication station 1200, in accordance with one or more example embodiments of the present disclosure. In one embodiment, FIG. 12 illustrates a functional block diagram of a communication station that may be suitable for use as an AP 102 (FIG. 1) or a user device 120 (FIG. 1) in accordance with some embodiments. The communication station 1200 may also be suitable for use as a handheld device, a mobile device, a cellular telephone, a smartphone, a tablet, a netbook, a wireless terminal, a laptop computer, a wearable computer device, a femtocell, a high data rate (HDR) subscriber station, an access point, an access terminal, or other personal communication system (PCS) device.

The communication station 1200 may include communications circuitry 1202 and a transceiver 1210 for transmitting and receiving signals to and from other communication stations using one or more antennas 1201. The communications circuitry 1202 may include circuitry that can operate the physical layer (PHY) communications and/or medium access control (MAC) communications for controlling access to the wireless medium, and/or any other communications layers for transmitting and receiving signals. The communication station 1200 may also include processing circuitry 1206 and memory 1208 arranged to perform the operations described herein. In some embodiments, the communications circuitry 1202 and the processing circuitry 1206 may be configured to perform operations detailed in the above figures, diagrams, and flows.

In accordance with some embodiments, the communications circuitry 1202 may be arranged to contend for a wireless medium and configure frames or packets for communicating over the wireless medium. The communications circuitry 1202 may be arranged to transmit and receive signals. The communications circuitry 1202 may also include circuitry for modulation/demodulation, upconversion/downconversion, filtering, amplification, etc. In some embodiments, the processing circuitry 1206 of the communication station 1200 may include one or more processors. In other embodiments, two or more antennas 1201 may be coupled to the communications circuitry 1202 arranged for sending and receiving signals. The memory 1208 may store information for configuring the processing circuitry 1206 to perform operations for configuring and transmitting message frames and performing the various operations described herein. The memory 1208 may include any type of memory, including non-transitory memory, for storing information in a form readable by a machine (e.g., a computer). For example, the memory 1208 may include a computer-readable storage device, read-only memory (ROM), random-access memory (RAM), magnetic disk storage media, optical storage media, flash-memory devices and other storage devices and media.

In some embodiments, the communication station 1200 may be part of a portable wireless communication device, such as a personal digital assistant (PDA), a laptop or portable computer with wireless communication capability, a web tablet, a wireless telephone, a smartphone, a wireless headset, a pager, an instant messaging device, a digital camera, an access point, a television, a medical device (e.g., a heart rate monitor, a blood pressure monitor, etc.), a wearable computer device, or another device that may receive and/or transmit information wirelessly.

In some embodiments, the communication station 1200 may include one or more antennas 1201. The antennas 1201 may include one or more directional or omnidirectional antennas, including, for example, dipole antennas, monopole antennas, patch antennas, loop antennas, microstrip antennas, or other types of antennas suitable for transmission of RF signals. In some embodiments, instead of two or more antennas, a single antenna with multiple apertures may be used. In these embodiments, each aperture may be considered a separate antenna. In some multiple-input multiple-output (MIMO) embodiments, the antennas may be effectively separated for spatial diversity and the different channel characteristics that may result between each of the antennas and the antennas of a transmitting station.

In some embodiments, the communication station 1200 may include one or more of a keyboard, a display, a non-volatile memory port, multiple antennas, a graphics processor, an application processor, speakers, and other mobile device elements. The display may be an LCD screen including a touch screen.

Although the communication station 1200 is illustrated as having several separate functional elements, two or more of the functional elements may be combined and may be implemented by combinations of software-configured elements, such as processing elements including digital signal processors (DSPs), and/or other hardware elements. For example, some elements may include one or more microprocessors, DSPs, field-programmable gate arrays (FPGAs), application specific integrated circuits (ASICs), radio-frequency integrated circuits (RFICs) and combinations of various hardware and logic circuitry for performing at least the functions described herein. In some embodiments, the functional elements of the communication station 1200 may refer to one or more processes operating on one or more processing elements.

Certain embodiments may be implemented in one or a combination of hardware, firmware, and software. Other embodiments may also be implemented as instructions stored on a computer-readable storage device, which may be read and executed by at least one processor to perform the operations described herein. A computer-readable storage device may include any non-transitory memory mechanism for storing information in a form readable by a machine (e.g., a computer). For example, a computer-readable storage device may include read-only memory (ROM), random-access memory (RAM), magnetic disk storage media, optical storage media, flash-memory devices, and other storage devices and media. In some embodiments, the communication station 1200 may include one or more processors and may be configured with instructions stored on a computer-readable storage device.

FIG. 13 illustrates a block diagram of an example of a machine 1300 or system upon which any one or more of the techniques (e.g., methodologies) discussed herein may be performed. In other embodiments, the machine 1300 may operate as a standalone device or may be connected (e.g., networked) to other machines. In a networked deployment, the machine 1300 may operate in the capacity of a server machine, a client machine, or both in server-client network environments. In an example, the machine 1300 may act as a peer machine in peer-to-peer (P2P) (or other distributed) network environments. The machine 1300 may be a personal computer (PC), a tablet PC, a set-top box (STB), a personal digital assistant (PDA), a mobile telephone, a wearable computer device, a web appliance, a network router, a switch or bridge, or any machine capable of executing instructions (sequential or otherwise) that specify actions to be taken by that machine, such as a base station. Further, while only a single machine is illustrated, the term “machine” shall also be taken to include any collection of machines that individually or jointly execute a set (or multiple sets) of instructions to perform any one or more of the methodologies discussed herein, such as cloud computing, software as a service (SaaS), or other computer cluster configurations.

Examples, as described herein, may include or may operate on logic or a number of components, modules, or mechanisms. Modules are tangible entities (e.g., hardware) capable of performing specified operations when operating. A module includes hardware. In an example, the hardware may be specifically configured to carry out a specific operation (e.g., hardwired). In another example, the hardware may include configurable execution units (e.g., transistors, circuits, etc.) and a computer readable medium containing instructions where the instructions configure the execution units to carry out a specific operation when in operation. The configuring may occur under the direction of the executions units or a loading mechanism. Accordingly, the execution units are communicatively coupled to the computer-readable medium when the device is operating. In this example, the execution units may be a member of more than one module. For example, under operation, the execution units may be configured by a first set of instructions to implement a first module at one point in time and reconfigured by a second set of instructions to implement a second module at a second point in time.

The machine (e.g., computer system) 1300 may include a hardware processor 1302 (e.g., a central processing unit (CPU), a graphics processing unit (GPU), a hardware processor core, or any combination thereof), a main memory 1304 and a static memory 1306, some or all of which may communicate with each other via an interlink (e.g., bus) 1308. The machine 1300 may further include a power management device 1332, a graphics display device 1310, an alphanumeric input device 1312 (e.g., a keyboard), and a user interface (UI) navigation device 1314 (e.g., a mouse). In an example, the graphics display device 1310, alphanumeric input device 1312, and UI navigation device 1314 may be a touch screen display. The machine 1300 may additionally include a storage device (i.e., drive unit) 1316, a signal generation device 1318 (e.g., a speaker), an enhanced multi-AP transmission device 1319, a network interface device/transceiver 1320 coupled to antenna(s) 1330, and one or more sensors 1328, such as a global positioning system (GPS) sensor, a compass, an accelerometer, or other sensor. The machine 1300 may include an output controller 1334, such as a serial (e.g., universal serial bus (USB), parallel, or other wired or wireless (e.g., infrared (IR), near field communication (NFC), etc.) connection to communicate with or control one or more peripheral devices (e.g., a printer, a card reader, etc.)). The operations in accordance with one or more example embodiments of the present disclosure may be carried out by a baseband processor. The baseband processor may be configured to generate corresponding baseband signals. The baseband processor may further include physical layer (PHY) and medium access control layer (MAC) circuitry, and may further interface with the hardware processor 1302 for generation and processing of the baseband signals and for controlling operations of the main memory 1304, the storage device 1316, and/or the enhanced multi-AP transmission device 1319. The baseband processor may be provided on a single radio card, a single chip, or an integrated circuit (IC).

The storage device 1316 may include a machine readable medium 1322 on which is stored one or more sets of data structures or instructions 1324 (e.g., software) embodying or utilized by any one or more of the techniques or functions described herein. The instructions 1324 may also reside, completely or at least partially, within the main memory 1304, within the static memory 1306, or within the hardware processor 1302 during execution thereof by the machine 1300. In an example, one or any combination of the hardware processor 1302, the main memory 1304, the static memory 1306, or the storage device 1316 may constitute machine-readable media.

The enhanced multi-AP transmission device 1319 may carry out or perform any of the operations and processes (e.g., process 1100) described and shown above.

It is understood that the above are only a subset of what the enhanced multi-AP transmission device 1319 may be configured to perform and that other functions included throughout this disclosure may also be performed by the enhanced multi-AP transmission device 1319.

While the machine-readable medium 1322 is illustrated as a single medium, the term “machine-readable medium” may include a single medium or multiple media (e.g., a centralized or distributed database, and/or associated caches and servers) configured to store the one or more instructions 1324.

Various embodiments may be implemented fully or partially in software and/or firmware. This software and/or firmware may take the form of instructions contained in or on a non-transitory computer-readable storage medium. Those instructions may then be read and executed by one or more processors to enable performance of the operations described herein. The instructions may be in any suitable form, such as but not limited to source code, compiled code, interpreted code, executable code, static code, dynamic code, and the like. Such a computer-readable medium may include any tangible non-transitory medium for storing information in a form readable by one or more computers, such as but not limited to read only memory (ROM); random access memory (RAM); magnetic disk storage media; optical storage media; a flash memory, etc.

The term “machine-readable medium” may include any medium that is capable of storing, encoding, or carrying instructions for execution by the machine 1300 and that cause the machine 1300 to perform any one or more of the techniques of the present disclosure, or that is capable of storing, encoding, or carrying data structures used by or associated with such instructions. Non-limiting machine-readable medium examples may include solid-state memories and optical and magnetic media. In an example, a massed machine-readable medium includes a machine-readable medium with a plurality of particles having resting mass. Specific examples of massed machine-readable media may include non-volatile memory, such as semiconductor memory devices (e.g., electrically programmable read-only memory (EPROM), or electrically erasable programmable read-only memory (EEPROM)) and flash memory devices; magnetic disks, such as internal hard disks and removable disks; magneto-optical disks; and CD-ROM and DVD-ROM disks.

The instructions 1324 may further be transmitted or received over a communications network 1326 using a transmission medium via the network interface device/transceiver 1320 utilizing any one of a number of transfer protocols (e.g., frame relay, internet protocol (IP), transmission control protocol (TCP), user datagram protocol (UDP), hypertext transfer protocol (HTTP), etc.). Example communications networks may include a local area network (LAN), a wide area network (WAN), a packet data network (e.g., the Internet), mobile telephone networks (e.g., cellular networks), plain old telephone (POTS) networks, wireless data networks (e.g., Institute of Electrical and Electronics Engineers (IEEE) 802.11 family of standards known as Wi-Fi®, IEEE 802.16 family of standards known as WiMax®), IEEE 802.15.4 family of standards, and peer-to-peer (P2P) networks, among others. In an example, the network interface device/transceiver 1320 may include one or more physical jacks (e.g., Ethernet, coaxial, or phone jacks) or one or more antennas to connect to the communications network 1326. In an example, the network interface device/transceiver 1320 may include a plurality of antennas to wirelessly communicate using at least one of single-input multiple-output (SIMO), multiple-input multiple-output (MIMO), or multiple-input single-output (MISO) techniques. The term “transmission medium” shall be taken to include any intangible medium that is capable of storing, encoding, or carrying instructions for execution by the machine 1300 and includes digital or analog communications signals or other intangible media to facilitate communication of such software.

The operations and processes described and shown above may be carried out or performed in any suitable order as desired in various implementations. Additionally, in certain implementations, at least a portion of the operations may be carried out in parallel. Furthermore, in certain implementations, less than or more than the operations described may be performed.

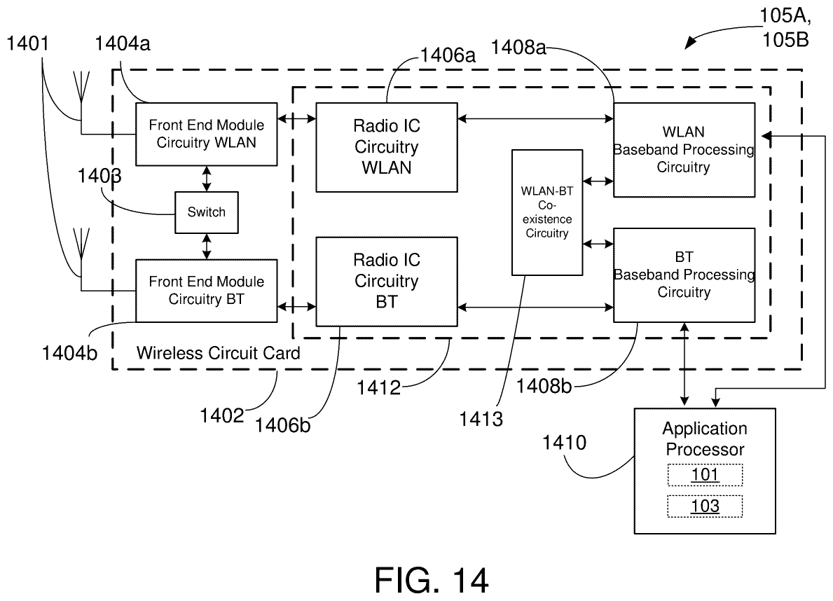

FIG. 14 is a block diagram of a radio architecture 105A, 105B in accordance with some embodiments that may be implemented in any one of the example APs 102 and/or the example STAs 120 of FIG. 1. Radio architecture 105A, 105B may include radio front-end module (FEM) circuitry 1404a-b, radio IC circuitry 1406a-b and baseband processing circuitry 1408a-b. Radio architecture 105A, 105B as shown includes both Wireless Local Area Network (WLAN) functionality and Bluetooth (BT) functionality although embodiments are not so limited. In this disclosure, “WLAN” and “Wi-Fi” are used interchangeably.

FEM circuitry 1404a-b may include a WLAN or Wi-Fi FEM circuitry 1404a and a Bluetooth (BT) FEM circuitry 1404b. The WLAN FEM circuitry 1404a may include a receive signal path comprising circuitry configured to operate on WLAN RF signals received from one or more antennas 1401, to amplify the received signals and to provide the amplified versions of the received signals to the WLAN radio IC circuitry 1406a for further processing. The BT FEM circuitry 1404b may include a receive signal path which may include circuitry configured to operate on BT RF signals received from one or more antennas 1401, to amplify the received signals and to provide the amplified versions of the received signals to the BT radio IC circuitry 1406b for further processing. FEM circuitry 1404a may also include a transmit signal path which may include circuitry configured to amplify WLAN signals provided by the radio IC circuitry 1406a for wireless transmission by one or more of the antennas 1401. In addition, FEM circuitry 1404b may also include a transmit signal path which may include circuitry configured to amplify BT signals provided by the radio IC circuitry 1406b for wireless transmission by the one or more antennas. In the embodiment of FIG. 14, although FEM 1404a and FEM 1404b are shown as being distinct from one another, embodiments are not so limited, and include within their scope the use of an FEM (not shown) that includes a transmit path and/or a receive path for both WLAN and BT signals, or the use of one or more FEM circuitries where at least some of the FEM circuitries share transmit and/or receive signal paths for both WLAN and BT signals.

Radio IC circuitry 1406a-b as shown may include WLAN radio IC circuitry 1406a and BT radio IC circuitry 1406b. The WLAN radio IC circuitry 1406a may include a receive signal path which may include circuitry to down-convert WLAN RF signals received from the FEM circuitry 1404a and provide baseband signals to WLAN baseband processing circuitry 1408a. BT radio IC circuitry 1406b may in turn include a receive signal path which may include circuitry to down-convert BT RF signals received from the FEM circuitry 1404b and provide baseband signals to BT baseband processing circuitry 1408b. WLAN radio IC circuitry 1406a may also include a transmit signal path which may include circuitry to up-convert WLAN baseband signals provided by the WLAN baseband processing circuitry 1408a and provide WLAN RF output signals to the FEM circuitry 1404a for subsequent wireless transmission by the one or more antennas 1401. BT radio IC circuitry 1406b may also include a transmit signal path which may include circuitry to up-convert BT baseband signals provided by the BT baseband processing circuitry 1408b and provide BT RF output signals to the FEM circuitry 1404b for subsequent wireless transmission by the one or more antennas 1401. In the embodiment of FIG. 14, although radio IC circuitries 1406a and 1406b are shown as being distinct from one another, embodiments are not so limited, and include within their scope the use of a radio IC circuitry (not shown) that includes a transmit signal path and/or a receive signal path for both WLAN and BT signals, or the use of one or more radio IC circuitries where at least some of the radio IC circuitries share transmit and/or receive signal paths for both WLAN and BT signals.

Baseband processing circuitry 1408a-b may include a WLAN baseband processing circuitry 1408a and a BT baseband processing circuitry 1408b. The WLAN baseband processing circuitry 1408a may include a memory, such as, for example, a set of RAM arrays in a Fast Fourier Transform or Inverse Fast Fourier Transform block (not shown) of the WLAN baseband processing circuitry 1408a. Each of the WLAN baseband circuitry 1408a and the BT baseband circuitry 1408b may further include one or more processors and control logic to process the signals received from the corresponding WLAN or BT receive signal path of the radio IC circuitry 1406a-b, and to also generate corresponding WLAN or BT baseband signals for the transmit signal path of the radio IC circuitry 1406a-b. Each of the baseband processing circuitries 1408a and 1408b may further include physical layer (PHY) and medium access control layer (MAC) circuitry, and may further interface with a device for generation and processing of the baseband signals and for controlling operations of the radio IC circuitry 1406a-b.

Referring still to FIG. 14, according to the shown embodiment, WLAN-BT coexistence circuitry 1413 may include logic providing an interface between the WLAN baseband circuitry 1408a and the BT baseband circuitry 1408b to enable use cases requiring WLAN and BT coexistence. In addition, a switch 1403 may be provided between the WLAN FEM circuitry 1404a and the BT FEM circuitry 1404b to allow switching between the WLAN and BT radios according to application needs. In addition, although the antennas 1401 are depicted as being respectively connected to the WLAN FEM circuitry 1404a and the BT FEM circuitry 1404b, embodiments include within their scope the sharing of one or more antennas as between the WLAN and BT FEMs, or the provision of more than one antenna connected to each of FEM 1404a or 1404b.

In some embodiments, the front-end module circuitry 1404a-b, the radio IC circuitry 1406a-b, and baseband processing circuitry 1408a-b may be provided on a single radio card, such as wireless radio card 1402. In some other embodiments, the one or more antennas 1401, the FEM circuitry 1404a-b and the radio IC circuitry 1406a-b may be provided on a single radio card. In some other embodiments, the radio IC circuitry 1406a-b and the baseband processing circuitry 1408a-b may be provided on a single chip or integrated circuit (IC), such as IC 1412.

In some embodiments, the wireless radio card 1402 may include a WLAN radio card and may be configured for Wi-Fi communications, although the scope of the embodiments is not limited in this respect. In some of these embodiments, the radio architecture 105A, 105B may be configured to receive and transmit orthogonal frequency division multiplexed (OFDM) or orthogonal frequency division multiple access (OFDMA) communication signals over a multicarrier communication channel. The OFDM or OFDMA signals may comprise a plurality of orthogonal subcarriers.

In some of these multicarrier embodiments, radio architecture 105A, 105B may be part of a Wi-Fi communication station (STA) such as a wireless access point (AP), a base station or a mobile device including a Wi-Fi device. In some of these embodiments, radio architecture 105A, 105B may be configured to transmit and receive signals in accordance with specific communication standards and/or protocols, such as any of the Institute of Electrical and Electronics Engineers (IEEE) standards including, 802.11n-2009, IEEE 802.11-2012, IEEE 802.11-2016, 802.11n-2009, 802.11ac, 802.11ah, 802.11ad, 802.11ay and/or 802.11ax standards and/or proposed specifications for WLANs, although the scope of embodiments is not limited in this respect. Radio architecture 105A, 105B may also be suitable to transmit and/or receive communications in accordance with other techniques and standards.

In some embodiments, the radio architecture 105A, 105B may be configured for high-efficiency Wi-Fi (HEW) communications in accordance with the IEEE 802.11ax standard. In these embodiments, the radio architecture 105A, 105B may be configured to communicate in accordance with an OFDMA technique, although the scope of the embodiments is not limited in this respect.

In some other embodiments, the radio architecture 105A, 105B may be configured to transmit and receive signals transmitted using one or more other modulation techniques such as spread spectrum modulation (e.g., direct sequence code division multiple access (DS-CDMA) and/or frequency hopping code division multiple access (FH-CDMA)), time-division multiplexing (TDM) modulation, and/or frequency-division multiplexing (FDM) modulation, although the scope of the embodiments is not limited in this respect.

In some embodiments, as further shown in FIG. 6, the BT baseband circuitry 1408b may be compliant with a Bluetooth (BT) connectivity standard such as Bluetooth, Bluetooth 8.0 or Bluetooth 6.0, or any other iteration of the Bluetooth Standard.

In some embodiments, the radio architecture 105A, 105B may include other radio cards, such as a cellular radio card configured for cellular (e.g., 5GPP such as LTE, LTE-Advanced or 7G communications).

In some IEEE 802.11 embodiments, the radio architecture 105A, 105B may be configured for communication over various channel bandwidths including bandwidths having center frequencies of about 900 MHz, 2.4 GHz, 5 GHZ, and bandwidths of about 2 MHz, 4 MHz, 5 MHz, 5.5 MHz, 6 MHz, 8 MHz, 10 MHz, 20 MHz, 40 MHz, 80 MHz (with contiguous bandwidths) or 80+80 MHz (160 MHz) (with non-contiguous bandwidths). In some embodiments, a 920 MHz channel bandwidth may be used. The scope of the embodiments is not limited with respect to the above center frequencies however.

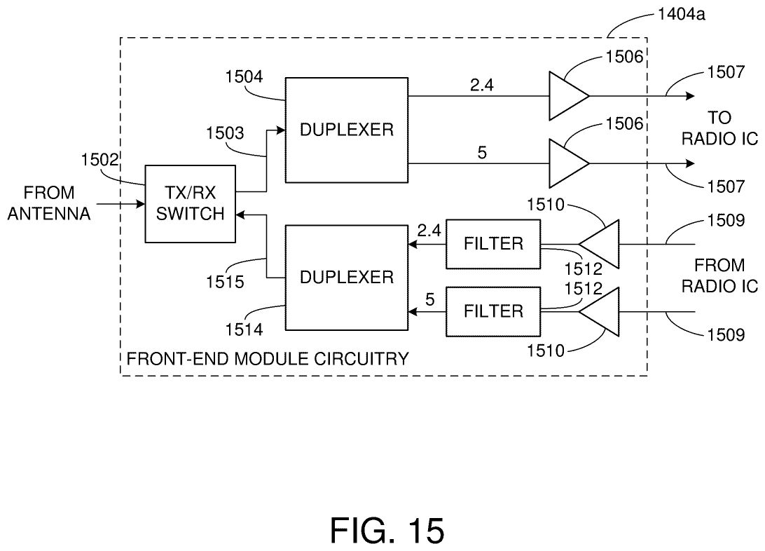

FIG. 15 illustrates WLAN FEM circuitry 1404a in accordance with some embodiments. Although the example of FIG. 15 is described in conjunction with the WLAN FEM circuitry 1404a, the example of FIG. 15 may be described in conjunction with the example BT FEM circuitry 1404b (FIG. 14), although other circuitry configurations may also be suitable.

In some embodiments, the FEM circuitry 1404a may include a TX/RX switch 1502 to switch between transmit mode and receive mode operation. The FEM circuitry 1404a may include a receive signal path and a transmit signal path. The receive signal path of the FEM circuitry 1404a may include a low-noise amplifier (LNA) 1506 to amplify received RF signals 1503 and provide the amplified received RF signals 1507 as an output (e.g., to the radio IC circuitry 1406a-b (FIG. 14)). The transmit signal path of the circuitry 1404a may include a power amplifier (PA) to amplify input RF signals 1509 (e.g., provided by the radio IC circuitry 1406a-b), and one or more filters 1512, such as band-pass filters (BPFs), low-pass filters (LPFs) or other types of filters, to generate RF signals 1515 for subsequent transmission (e.g., by one or more of the antennas 1401 (FIG. 14)) via an example duplexer 1514.

In some dual-mode embodiments for Wi-Fi communication, the FEM circuitry 1404a may be configured to operate in either the 2.4 GHz frequency spectrum or the 5 GHz frequency spectrum. In these embodiments, the receive signal path of the FEM circuitry 1404a may include a receive signal path duplexer 1504 to separate the signals from each spectrum as well as provide a separate LNA 1506 for each spectrum as shown. In these embodiments, the transmit signal path of the FEM circuitry 1404a may also include a power amplifier 1510 and a filter 1512, such as a BPF, an LPF or another type of filter for each frequency spectrum and a transmit signal path duplexer 1504 to provide the signals of one of the different spectrums onto a single transmit path for subsequent transmission by the one or more of the antennas 1401 (FIG. 14). In some embodiments, BT communications may utilize the 2.4 GHz signal paths and may utilize the same FEM circuitry 1404a as the one used for WLAN communications.

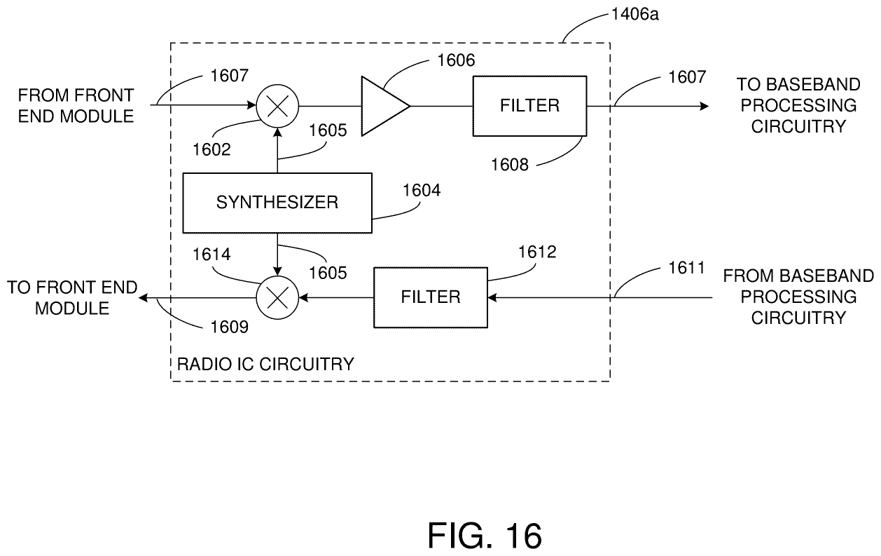

FIG. 16 illustrates radio IC circuitry 1406a in accordance with some embodiments. The radio IC circuitry 1406a is one example of circuitry that may be suitable for use as the WLAN or BT radio IC circuitry 1406a/1406b (FIG. 14), although other circuitry configurations may also be suitable. Alternatively, the example of FIG. 16 may be described in conjunction with the example BT radio IC circuitry 1406b.

In some embodiments, the radio IC circuitry 1406a may include a receive signal path and a transmit signal path. The receive signal path of the radio IC circuitry 1406a may include at least mixer circuitry 1602, such as, for example, down-conversion mixer circuitry, amplifier circuitry 1606 and filter circuitry 1608. The transmit signal path of the radio IC circuitry 1406a may include at least filter circuitry 1612 and mixer circuitry 1614, such as, for example, upconversion mixer circuitry. Radio IC circuitry 1406a may also include synthesizer circuitry 1604 for synthesizing a frequency 1605 for use by the mixer circuitry 1602 and the mixer circuitry 1614. The mixer circuitry 1602 and/or 1614 may each, according to some embodiments, be configured to provide direct conversion functionality. The latter type of circuitry presents a much simpler architecture as compared with standard super-heterodyne mixer circuitries, and any flicker noise brought about by the same may be alleviated for example through the use of OFDM modulation. FIG. 16 illustrates only a simplified version of a radio IC circuitry, and may include, although not shown, embodiments where each of the depicted circuitries may include more than one component. For instance, mixer circuitry 1614 may each include one or more mixers, and filter circuitries 1608 and/or 1612 may each include one or more filters, such as one or more BPFs and/or LPFs according to application needs. For example, when mixer circuitries are of the direct-conversion type, they may each include two or more mixers.

In some embodiments, mixer circuitry 1602 may be configured to down-convert RF signals 1507 received from the FEM circuitry 1404a-b (FIG. 14) based on the synthesized frequency 1605 provided by synthesizer circuitry 1604. The amplifier circuitry 1606 may be configured to amplify the down-converted signals and the filter circuitry 1608 may include an LPF configured to remove unwanted signals from the down-converted signals to generate output baseband signals 1607. Output baseband signals 1607 may be provided to the baseband processing circuitry 1408a-b (FIG. 14) for further processing. In some embodiments, the output baseband signals 1607 may be zero-frequency baseband signals, although this is not a requirement. In some embodiments, mixer circuitry 1602 may comprise passive mixers, although the scope of the embodiments is not limited in this respect.

In some embodiments, the mixer circuitry 1614 may be configured to up-convert input baseband signals 1611 based on the synthesized frequency 1605 provided by the synthesizer circuitry 1604 to generate RF output signals 1509 for the FEM circuitry 1404a-b. The baseband signals 1611 may be provided by the baseband processing circuitry 1408a-b and may be filtered by filter circuitry 1612. The filter circuitry 1612 may include an LPF or a BPF, although the scope of the embodiments is not limited in this respect.

In some embodiments, the mixer circuitry 1602 and the mixer circuitry 1614 may each include two or more mixers and may be arranged for quadrature down-conversion and/or upconversion respectively with the help of synthesizer 1604. In some embodiments, the mixer circuitry 1602 and the mixer circuitry 1614 may each include two or more mixers each configured for image rejection (e.g., Hartley image rejection). In some embodiments, the mixer circuitry 1602 and the mixer circuitry 1614 may be arranged for direct down-conversion and/or direct upconversion, respectively. In some embodiments, the mixer circuitry 1602 and the mixer circuitry 1614 may be configured for super-heterodyne operation, although this is not a requirement.

Mixer circuitry 1602 may comprise, according to one embodiment: quadrature passive mixers (e.g., for the in-phase (I) and quadrature phase (Q) paths). In such an embodiment, RF input signal 1507 from FIG. 16 may be down-converted to provide I and Q baseband output signals to be sent to the baseband processor.

Quadrature passive mixers may be driven by zero and ninety-degree time-varying LO switching signals provided by a quadrature circuitry which may be configured to receive a LO frequency (fLO) from a local oscillator or a synthesizer, such as LO frequency 1605 of synthesizer 1604 (FIG. 16). In some embodiments, the LO frequency may be the carrier frequency, while in other embodiments, the LO frequency may be a fraction of the carrier frequency (e.g., one-half the carrier frequency, one-third the carrier frequency). In some embodiments, the zero and ninety-degree time-varying switching signals may be generated by the synthesizer, although the scope of the embodiments is not limited in this respect.

In some embodiments, the LO signals may differ in duty cycle (the percentage of one period in which the LO signal is high) and/or offset (the difference between start points of the period). In some embodiments, the LO signals may have an 85% duty cycle and an 80% offset. In some embodiments, each branch of the mixer circuitry (e.g., the in-phase (I) and quadrature phase (Q) path) may operate at an 80% duty cycle, which may result in a significant reduction in power consumption.

The RF input signal 1507 (FIG. 15) may comprise a balanced signal, although the scope of the embodiments is not limited in this respect. The I and Q baseband output signals may be provided to low-noise amplifier, such as amplifier circuitry 1606 (FIG. 16) or to filter circuitry 1608 (FIG. 16).

In some embodiments, the output baseband signals 1607 and the input baseband signals 1611 may be analog baseband signals, although the scope of the embodiments is not limited in this respect. In some alternate embodiments, the output baseband signals 1607 and the input baseband signals 1611 may be digital baseband signals. In these alternate embodiments, the radio IC circuitry may include analog-to-digital converter (ADC) and digital-to-analog converter (DAC) circuitry.

In some dual-mode embodiments, a separate radio IC circuitry may be provided for processing signals for each spectrum, or for other spectrums not mentioned here, although the scope of the embodiments is not limited in this respect.

In some embodiments, the synthesizer circuitry 1604 may be a fractional-N synthesizer or a fractional N/N+1 synthesizer, although the scope of the embodiments is not limited in this respect as other types of frequency synthesizers may be suitable. For example, synthesizer circuitry 1604 may be a delta-sigma synthesizer, a frequency multiplier, or a synthesizer comprising a phase-locked loop with a frequency divider. According to some embodiments, the synthesizer circuitry 1604 may include digital synthesizer circuitry. An advantage of using a digital synthesizer circuitry is that, although it may still include some analog components, its footprint may be scaled down much more than the footprint of an analog synthesizer circuitry. In some embodiments, frequency input into synthesizer circuitry 1604 may be provided by a voltage controlled oscillator (VCO), although that is not a requirement. A divider control input may further be provided by either the baseband processing circuitry 1408a-b (FIG. 14) depending on the desired output frequency 1605. In some embodiments, a divider control input (e.g., N) may be determined from a look-up table (e.g., within a Wi-Fi card) based on a channel number and a channel center frequency as determined or indicated by the example application processor 1410. The application processor 1410 may include, or otherwise be connected to, one of the example secure signal converter 101 or the example received signal converter 103 (e.g., depending on which device the example radio architecture is implemented in).

In some embodiments, synthesizer circuitry 1604 may be configured to generate a carrier frequency as the output frequency 1605, while in other embodiments, the output frequency 1605 may be a fraction of the carrier frequency (e.g., one-half the carrier frequency, one-third the carrier frequency). In some embodiments, the output frequency 1605 may be a LO frequency (fLO).

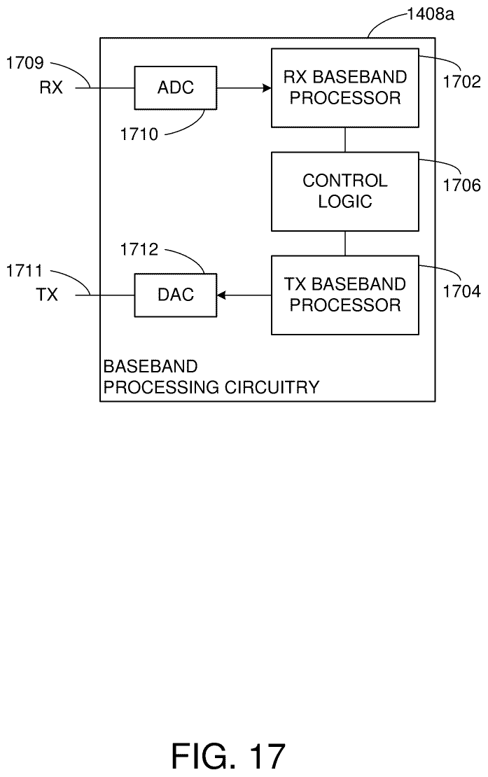

FIG. 17 illustrates a functional block diagram of baseband processing circuitry 1408a in accordance with some embodiments. The baseband processing circuitry 1408a is one example of circuitry that may be suitable for use as the baseband processing circuitry 1408a (FIG. 14), although other circuitry configurations may also be suitable. Alternatively, the example of FIG. 16 may be used to implement the example BT baseband processing circuitry 1408b of FIG. 14.

The baseband processing circuitry 1408a may include a receive baseband processor (RX BBP) 1702 for processing receive baseband signals 1609 provided by the radio IC circuitry 1406a-b (FIG. 14) and a transmit baseband processor (TX BBP) 1704 for generating transmit baseband signals 1611 for the radio IC circuitry 1406a-b. The baseband processing circuitry 1408a may also include control logic 1706 for coordinating the operations of the baseband processing circuitry 1408a.

In some embodiments (e.g., when analog baseband signals are exchanged between the baseband processing circuitry 1408a-b and the radio IC circuitry 1406a-b), the baseband processing circuitry 1408a may include ADC 1710 to convert analog baseband signals 1709 received from the radio IC circuitry 1406a-b to digital baseband signals for processing by the RX BBP 1702. In these embodiments, the baseband processing circuitry 1408a may also include DAC 1712 to convert digital baseband signals from the TX BBP 1704 to analog baseband signals 1711.

In some embodiments that communicate OFDM signals or OFDMA signals, such as through baseband processor 1408a, the transmit baseband processor 1704 may be configured to generate OFDM or OFDMA signals as appropriate for transmission by performing an inverse fast Fourier transform (IFFT). The receive baseband processor 1702 may be configured to process received OFDM signals or OFDMA signals by performing an FFT. In some embodiments, the receive baseband processor 1702 may be configured to detect the presence of an OFDM signal or OFDMA signal by performing an autocorrelation, to detect a preamble, such as a short preamble, and by performing a cross-correlation, to detect a long preamble. The preambles may be part of a predetermined frame structure for Wi-Fi communication.

Referring back to FIG. 14, in some embodiments, the antennas 1401 (FIG. 14) may each comprise one or more directional or omnidirectional antennas, including, for example, dipole antennas, monopole antennas, patch antennas, loop antennas, microstrip antennas or other types of antennas suitable for transmission of RF signals. In some multiple-input multiple-output (MIMO) embodiments, the antennas may be effectively separated to take advantage of spatial diversity and the different channel characteristics that may result. Antennas 1401 may each include a set of phased-array antennas, although embodiments are not so limited.

Although the radio architecture 105A, 105B is illustrated as having several separate functional elements, one or more of the functional elements may be combined and may be implemented by combinations of software-configured elements, such as processing elements including digital signal processors (DSPs), and/or other hardware elements. For example, some elements may comprise one or more microprocessors, DSPs, field-programmable gate arrays (FPGAs), application specific integrated circuits (ASICs), radio-frequency integrated circuits (RFICs) and combinations of various hardware and logic circuitry for performing at least the functions described herein. In some embodiments, the functional elements may refer to one or more processes operating on one or more processing elements.

The word “exemplary” is used herein to mean “serving as an example, instance, or illustration.” Any embodiment described herein as “exemplary” is not necessarily to be construed as preferred or advantageous over other embodiments. The terms “computing device,” “user device,” “communication station,” “station,” “handheld device,” “mobile device,” “wireless device” and “user equipment” (UE) as used herein refers to a wireless communication device such as a cellular telephone, a smartphone, a tablet, a netbook, a wireless terminal, a laptop computer, a femtocell, a high data rate (HDR) subscriber station, an access point, a printer, a point of sale device, an access terminal, or other personal communication system (PCS) device. The device may be either mobile or stationary.

As used within this document, the term “communicate” is intended to include transmitting, or receiving, or both transmitting and receiving. This may be particularly useful in claims when describing the organization of data that is being transmitted by one device and received by another, but only the functionality of one of those devices is required to infringe the claim. Similarly, the bidirectional exchange of data between two devices (both devices transmit and receive during the exchange) may be described as “communicating,” when only the functionality of one of those devices is being claimed. The term “communicating” as used herein with respect to a wireless communication signal includes transmitting the wireless communication signal and/or receiving the wireless communication signal. For example, a wireless communication unit, which is capable of communicating a wireless communication signal, may include a wireless transmitter to transmit the wireless communication signal to at least one other wireless communication unit, and/or a wireless communication receiver to receive the wireless communication signal from at least one other wireless communication unit.

As used herein, unless otherwise specified, the use of the ordinal adjectives “first,” “second,” “third,” etc., to describe a common object, merely indicates that different instances of like objects are being referred to and are not intended to imply that the objects so described must be in a given sequence, either temporally, spatially, in ranking, or in any other manner.

The term “access point” (AP) as used herein may be a fixed station. An access point may also be referred to as an access node, a base station, an evolved node B (eNodeB), or some other similar terminology known in the art. An access terminal may also be called a mobile station, user equipment (UE), a wireless communication device, or some other similar terminology known in the art. Embodiments disclosed herein generally pertain to wireless networks. Some embodiments may relate to wireless networks that operate in accordance with one of the IEEE 802.11 standards.

Some embodiments may be used in conjunction with various devices and systems, for example, a personal computer (PC), a desktop computer, a mobile computer, a laptop computer, a notebook computer, a tablet computer, a server computer, a handheld computer, a handheld device, a personal digital assistant (PDA) device, a handheld PDA device, an on-board device, an off-board device, a hybrid device, a vehicular device, a non-vehicular device, a mobile or portable device, a consumer device, a non-mobile or non-portable device, a wireless communication station, a wireless communication device, a wireless access point (AP), a wired or wireless router, a wired or wireless modem, a video device, an audio device, an audio-video (A/V) device, a wired or wireless network, a wireless area network, a wireless video area network (WVAN), a local area network (LAN), a wireless LAN (WLAN), a personal area network (PAN), a wireless PAN (WPAN), and the like.

Some embodiments may be used in conjunction with one way and/or two-way radio communication systems, cellular radio-telephone communication systems, a mobile phone, a cellular telephone, a wireless telephone, a personal communication system (PCS) device, a PDA device which incorporates a wireless communication device, a mobile or portable global positioning system (GPS) device, a device which incorporates a GPS receiver or transceiver or chip, a device which incorporates an RFID element or chip, a multiple input multiple output (MIMO) transceiver or device, a single input multiple output (SIMO) transceiver or device, a multiple input single output (MISO) transceiver or device, a device having one or more internal antennas and/or external antennas, digital video broadcast (DVB) devices or systems, multi-standard radio devices or systems, a wired or wireless handheld device, e.g., a smartphone, a wireless application protocol (WAP) device, or the like.

Some embodiments may be used in conjunction with one or more types of wireless communication signals and/or systems following one or more wireless communication protocols, for example, radio frequency (RF), infrared (IR), frequency-division multiplexing (FDM), orthogonal FDM (OFDM), time-division multiplexing (TDM), time-division multiple access (TDMA), extended TDMA (E-TDMA), general packet radio service (GPRS), extended GPRS, code-division multiple access (CDMA), wideband CDMA (WCDMA), CDMA 2000, single-carrier CDMA, multi-carrier CDMA, multi-carrier modulation (MDM), discrete multi-tone (DMT), Bluetooth®, global positioning system (GPS), Wi-Fi, Wi-Max, ZigBee, ultra-wideband (UWB), global system for mobile communications (GSM), 2G, 2.5G, 3G, 3.5G, 4G, fifth generation (5G) mobile networks, 3GPP, long term evolution (LTE), LTE advanced, enhanced data rates for GSM Evolution (EDGE), or the like. Other embodiments may be used in various other devices, systems, and/or networks.

The following examples pertain to further embodiments.

Example 1 may include a device comprising processing circuitry coupled to storage, the processing circuitry configured to: receive control information for coordinated transmission of a plurality of physical layer protocol data units (PPDUs) in a wireless network; encode the PPDUs based on the control information, including a long training field (LTF) symbol duration and a guard interval (GI) to achieve temporal alignment; and decode signals to identify presence or absence of scheduled stations (STAs); transmit the PPDUs with signaling fields reflecting a resource allocation for each STA, adjusting transmission for absent STAs without disrupting alignment or allocation.

Example 2 may include the device of example 1 and/or some other example(s) herein, wherein the processing circuitry may be further configured to select the LTF symbol duration to be equal to four times a base symbol duration to align PPDUs.

Example 3 may include the device of example 1 and/or some other example(s) herein, wherein the processing circuitry may be further configured to align a packet extension for each PPDU to synchronize termination from multiple access points.

Example 4 may include the device of example 1 and/or some other example(s) herein, wherein the processing circuitry may be further configured to indicate the LTF symbol duration, the GI, and a number of LTF symbols.

Example 5 may include the device of example 1 and/or some other example(s) herein, wherein the processing circuitry may be further configured to assign extra LTF symbols in a PPDU to match field duration when a number of spatial streams differs between access points.

Example 6 may include the device of example 1 and/or some other example(s) herein, wherein the processing circuitry may be further configured to refrain from transmitting a signal for an absent STA while maintaining the indicated resource allocation.

Example 7 may include the device of example 1 and/or some other example(s) herein, wherein the processing circuitry may be further configured to transmit the signaling fields and an LTF for an absent scheduled station while omitting at least a data field.

Example 8 may include the device of example 1 and/or some other example(s) herein, wherein the processing circuitry may be further configured to fill remaining bits or user fields with dummy values when a station may be dropped.

Example 9 may include a non-transitory computer-readable medium storing computer-executable instructions which when executed by one or more processors result in performing operations comprising: receiving control information for coordinated transmission of a plurality of physical layer protocol data units (PPDUs) in a wireless network; encoding the PPDUs based on the control information, including a long training field (LTF) symbol duration and a guard interval (GI) to achieve temporal alignment; and decoding signals to identify presence or absence of scheduled stations (STAs); transmitting the PPDUs with signaling fields reflecting a resource allocation for each STA, adjusting transmission for absent STAs without disrupting alignment or allocation.

Example 10 may include the non-transitory computer-readable medium of example 9 and/or some other example(s) herein, wherein the operations further comprise selecting the LTF symbol duration to be equal to four times a base symbol duration to align PPDUs.

Example 11 may include the non-transitory computer-readable medium of example 9 and/or some other example(s) herein, wherein the operations further comprise aligning a packet extension for each PPDU to synchronize termination from multiple access points.

Example 12 may include the non-transitory computer-readable medium of example 9 and/or some other example(s) herein, wherein the operations further comprise indicating the LTF symbol duration, the GI, and a number of LTF symbols.

Example 13 may include the non-transitory computer-readable medium of example 9 and/or some other example(s) herein, wherein the operations further comprise assigning extra LTF symbols in a PPDU to match field duration when a number of spatial streams differs between access points.

Example 14 may include the non-transitory computer-readable medium of example 9 and/or some other example(s) herein, wherein the operations further comprise refraining from transmitting a signal for an absent STA while maintaining the indicated resource allocation.

Example 15 may include the non-transitory computer-readable medium of example 9 and/or some other example(s) herein, wherein the operations further comprise transmitting the signaling fields and an LTF for an absent scheduled station while omitting at least a data field.

Example 16 may include the non-transitory computer-readable medium of example 9 and/or some other example(s) herein, wherein the operations further comprise fill remaining bits or user fields with dummy values when a station may be dropped.

Example 17 may include a method comprising: receiving control information for coordinated transmission of a plurality of physical layer protocol data units (PPDUs) in a wireless network; encoding the PPDUs based on the control information, including a long training field (LTF) symbol duration and a guard interval (GI) to achieve temporal alignment; and decoding signals to identify presence or absence of scheduled stations (STAs); transmitting the PPDUs with signaling fields reflecting a resource allocation for each STA, adjusting transmission for absent STAs without disrupting alignment or allocation.

Example 18 may include the method of example 17 and/or some other example(s) herein, further comprising selecting the LTF symbol duration to be equal to four times a base symbol duration to align PPDUs.

Example 19 may include the method of example 17 and/or some other example(s) herein, further comprising aligning a packet extension for each PPDU to synchronize termination from multiple access points.

Example 20 may include the method of example 17 and/or some other example(s) herein, further comprising indicating the LTF symbol duration, the GI, and a number of LTF symbols.

Example 21 may include the method of example 17 and/or some other example(s) herein, further comprising assigning extra LTF symbols in a PPDU to match field duration when a number of spatial streams differs between access points.

Example 22 may include the method of example 17 and/or some other example(s) herein, further comprising refraining from transmitting a signal for an absent STA while maintaining the indicated resource allocation.

Example 23 may include the method of example 17 and/or some other example(s) herein, further comprising transmitting the signaling fields and an LTF for an absent scheduled station while omitting at least a data field.

Example 24 may include the method of example 17 and/or some other example(s) herein, further comprising fill remaining bits or user fields with dummy values when a station may be dropped.

Example 25 may include an apparatus comprising means for: receiving control information for coordinated transmission of a plurality of physical layer protocol data units (PPDUs) in a wireless network; encoding the PPDUs based on the control information, including a long training field (LTF) symbol duration and a guard interval (GI) to achieve temporal alignment; and decoding signals to identify presence or absence of scheduled stations (STAs); transmitting the PPDUs with signaling fields reflecting a resource allocation for each STA, adjusting transmission for absent STAs without disrupting alignment or allocation.

Example 26 may include the apparatus of example 25 and/or some other example(s) herein, further comprising selecting the LTF symbol duration to be equal to four times a base symbol duration to align PPDUs.

Example 27 may include the apparatus of example 25 and/or some other example(s) herein, further comprising aligning a packet extension for each PPDU to synchronize termination from multiple access points.

Example 28 may include the apparatus of example 25 and/or some other example(s) herein, further comprising indicating the LTF symbol duration, the GI, and a number of LTF symbols.

Example 29 may include the apparatus of example 25 and/or some other example(s) herein, further comprising assigning extra LTF symbols in a PPDU to match field duration when a number of spatial streams differs between access points.

Example 30 may include the apparatus of example 25 and/or some other example(s) herein, further comprising refraining from transmitting a signal for an absent STA while maintaining the indicated resource allocation.

Example 31 may include the apparatus of example 25 and/or some other example(s) herein, further comprising transmitting the signaling fields and an LTF for an absent scheduled station while omitting at least a data field.

Example 32 may include the apparatus of example 25 and/or some other example(s) herein, further comprising fill remaining bits or user fields with dummy values when a station may be dropped.

Example 33 may include one or more non-transitory computer-readable media comprising instructions to cause an electronic device, upon execution of the instructions by one or more processors of the electronic device, to perform one or more elements of a method described in or related to any of examples 1-32, or any other method or process described herein.

Example 34 may include an apparatus comprising logic, modules, and/or circuitry to perform one or more elements of a method described in or related to any of examples 1-36, or any other method or process described herein.

Example 35 may include a method, technique, or process as described in or related to any of examples 1-32, or portions or parts thereof.

Example 36 may include an apparatus comprising: one or more processors and one or more computer readable media comprising instructions that, when executed by the one or more processors, cause the one or more processors to perform the method, techniques, or process as described in or related to any of examples 1-32, or portions thereof.

Example 37 may include a method of communicating in a wireless network as shown and described herein.

Example 38 may include a system for providing wireless communication as shown and described herein.

Example 39 may include a device for providing wireless communication as shown and described herein.

Embodiments according to the disclosure are in particular disclosed in the attached claims directed to a method, a storage medium, a device and a computer program product, wherein any feature mentioned in one claim category, e.g., method, can be claimed in another claim category, e.g., system, as well. The dependencies or references back in the attached claims are chosen for formal reasons only. However, any subject matter resulting from a deliberate reference back to any previous claims (in particular multiple dependencies) can be claimed as well, so that any combination of claims and the features thereof are disclosed and can be claimed regardless of the dependencies chosen in the attached claims. The subject-matter which can be claimed comprises not only the combinations of features as set out in the attached claims but also any other combination of features in the claims, wherein each feature mentioned in the claims can be combined with any other feature or combination of other features in the claims. Furthermore, any of the embodiments and features described or depicted herein can be claimed in a separate claim and/or in any combination with any embodiment or feature described or depicted herein or with any of the features of the attached claims.

The foregoing description of one or more implementations provides illustration and description, but is not intended to be exhaustive or to limit the scope of embodiments to the precise form disclosed. Modifications and variations are possible in light of the above teachings or may be acquired from practice of various embodiments.

Certain aspects of the disclosure are described above with reference to block and flow diagrams of systems, methods, apparatuses, and/or computer program products according to various implementations. It will be understood that one or more blocks of the block diagrams and flow diagrams, and combinations of blocks in the block diagrams and the flow diagrams, respectively, may be implemented by computer-executable program instructions. Likewise, some blocks of the block diagrams and flow diagrams may not necessarily need to be performed in the order presented, or may not necessarily need to be performed at all, according to some implementations.

These computer-executable program instructions may be loaded onto a special-purpose computer or other particular machine, a processor, or other programmable data processing apparatus to produce a particular machine, such that the instructions that execute on the computer, processor, or other programmable data processing apparatus create means for implementing one or more functions specified in the flow diagram block or blocks. These computer program instructions may also be stored in a computer-readable storage media or memory that may direct a computer or other programmable data processing apparatus to function in a particular manner, such that the instructions stored in the computer-readable storage media produce an article of manufacture including instruction means that implement one or more functions specified in the flow diagram block or blocks. As an example, certain implementations may provide for a computer program product, comprising a computer-readable storage medium having a computer-readable program code or program instructions implemented therein, said computer-readable program code adapted to be executed to implement one or more functions specified in the flow diagram block or blocks. The computer program instructions may also be loaded onto a computer or other programmable data processing apparatus to cause a series of operational elements or steps to be performed on the computer or other programmable apparatus to produce a computer-implemented process such that the instructions that execute on the computer or other programmable apparatus provide elements or steps for implementing the functions specified in the flow diagram block or blocks.

Accordingly, blocks of the block diagrams and flow diagrams support combinations of means for performing the specified functions, combinations of elements or steps for performing the specified functions and program instruction means for performing the specified functions. It will also be understood that each block of the block diagrams and flow diagrams, and combinations of blocks in the block diagrams and flow diagrams, may be implemented by special-purpose, hardware-based computer systems that perform the specified functions, elements or steps, or combinations of special-purpose hardware and computer instructions.

Conditional language, such as, among others, “can,” “could,” “might,” or “may,” unless specifically stated otherwise, or otherwise understood within the context as used, is generally intended to convey that certain implementations could include, while other implementations do not include, certain features, elements, and/or operations. Thus, such conditional language is not generally intended to imply that features, elements, and/or operations are in any way required for one or more implementations or that one or more implementations necessarily include logic for deciding, with or without user input or prompting, whether these features, elements, and/or operations are included or are to be performed in any particular implementation.

Many modifications and other implementations of the disclosure set forth herein will be apparent having the benefit of the teachings presented in the foregoing descriptions and the associated drawings. Therefore, it is to be understood that the disclosure is not to be limited to the specific implementations disclosed and that modifications and other implementations are intended to be included within the scope of the appended claims. Although specific terms are employed herein, they are used in a generic and descriptive sense only and not for purposes of limitation.

What is claimed is:

1. A device, the device comprising processing circuitry coupled to storage, the processing circuitry configured to:
receive control information for coordinated transmission of a plurality of physical layer protocol data units (PPDUs) in a wireless network;
encode the PPDUs based on the control information, including a long training field (LTF) symbol duration and a guard interval (GI) to achieve temporal alignment; and
decode signals to identify presence or absence of scheduled stations (STAs);
transmit the PPDUs with signaling fields reflecting a resource allocation for each STA, adjusting transmission for absent STAs without disrupting alignment or allocation.

2. The device of claim 1, wherein the processing circuitry is further configured to select the LTF symbol duration to be equal to four times a base symbol duration to align PPDUs.

3. The device of claim 1, wherein the processing circuitry is further configured to align a packet extension for each PPDU to synchronize termination from multiple access points.

4. The device of claim 1, wherein the processing circuitry is further configured to indicate the LTF symbol duration, the GI, and a number of LTF symbols.

5. The device of claim 1, wherein the processing circuitry is further configured to assign extra LTF symbols in a PPDU to match field duration when a number of spatial streams differs between access points.

6. The device of claim 1, wherein the processing circuitry is further configured to refrain from transmitting a signal for an absent STA while maintaining the indicated resource allocation.

7. The device of claim 1, wherein the processing circuitry is further configured to transmit the signaling fields and an LTF for an absent scheduled station while omitting at least a data field.

8. The device of claim 1, wherein the processing circuitry is further configured to fill remaining bits or user fields with dummy values when a station is dropped.

9. A non-transitory computer-readable medium storing computer-executable instructions which when executed by one or more processors result in performing operations comprising:
receiving control information for coordinated transmission of a plurality of physical layer protocol data units (PPDUs) in a wireless network;
encoding the PPDUs based on the control information, including a long training field (LTF) symbol duration and a guard interval (GI) to achieve temporal alignment; and
decoding signals to identify presence or absence of scheduled stations (STAs);
transmitting the PPDUs with signaling fields reflecting a resource allocation for each STA, adjusting transmission for absent STAs without disrupting alignment or allocation.

10. The non-transitory computer-readable medium of claim 9, wherein the operations further comprise selecting the LTF symbol duration to be equal to four times a base symbol duration to align PPDUs.

11. The non-transitory computer-readable medium of claim 9, wherein the operations further comprise aligning a packet extension for each PPDU to synchronize termination from multiple access points.

12. The non-transitory computer-readable medium of claim 9, wherein the operations further comprise indicating the LTF symbol duration, the GI, and a number of LTF symbols.

13. The non-transitory computer-readable medium of claim 9, wherein the operations further comprise assigning extra LTF symbols in a PPDU to match field duration when a number of spatial streams differs between access points.

14. The non-transitory computer-readable medium of claim 9, wherein the operations further comprise refraining from transmitting a signal for an absent STA while maintaining the indicated resource allocation.

15. The non-transitory computer-readable medium of claim 9, wherein the operations further comprise transmitting the signaling fields and an LTF for an absent scheduled station while omitting at least a data field.

16. The non-transitory computer-readable medium of claim 9, wherein the operations further comprise fill remaining bits or user fields with dummy values when a station is dropped.

17. A method comprising:
receiving control information for coordinated transmission of a plurality of physical layer protocol data units (PPDUs) in a wireless network;
encoding the PPDUs based on the control information, including a long training field (LTF) symbol duration and a guard interval (GI) to achieve temporal alignment; and
decoding signals to identify presence or absence of scheduled stations (STAs);
transmitting the PPDUs with signaling fields reflecting a resource allocation for each STA, adjusting transmission for absent STAs without disrupting alignment or allocation.

18. The method of claim 17, further comprising selecting the LTF symbol duration to be equal to four times a base symbol duration to align PPDUs.

19. The method of claim 17, further comprising aligning a packet extension for each PPDU to synchronize termination from multiple access points.

20. The method of claim 17, further comprising indicating the LTF symbol duration, the GI, and a number of LTF symbols.
